(19) United States
(12) Patent Application Publication
(10) Pub. No.: US 2025/0298568 A1
(43) Pub. Date: Sep. 25, 2025

(54) DYNAMIC USER INTERFACE INTERACTION BASED ON POSITION WITHIN A VEHICLE

(71) Applicant: The Toronto-Dominion Bank, Toronto (CA)

(72) Inventors: Mohamed Abbas, Jersey City, NJ (US); Pooja Abhishek Daryani, Fremont, CA (US); Richard Bruce Johnson, Cape Elizabeth, ME (US)

(73) Assignee: The Toronto-Dominion Bank, Toronto, ON (CA)

(21) Appl. No.: 18/614,799

(22) Filed: Mar. 25, 2024

(51) Int. Cl. G06F 3/14; B60K 35/22; B60K 35/65; G06Q 20/36

(52) U.S. Cl. CPC G06F 3/1423; G06Q 20/36; B60K 35/22; B60K 35/65

(57) ABSTRACT

An example operation may include one or more of communicating with a service provider via a head unit of a vehicle, capturing sensor data from an interior of the vehicle during an interaction between the service provider and an occupant within the vehicle, determining a location of the occupant within the vehicle based on the sensor data captured from the interior of the vehicle, and displaying data related to the interaction between the service provider and the occupant on a user interface from among a plurality of available user interfaces within the vehicle based on the location of the occupant within the vehicle. An artificial intelligence (AI) model can be trained and/or executed when performing at least one portion of the example operation.

### BACKGROUND

Vehicles are more “connected” to the outside world than ever before. As an example, a vehicle may communicate with a services provider (e.g., a restaurant, a toll booth, etc.), with smart devices/smart phones, other vehicles, and the like. Meanwhile, an automotive head unit (e.g., infotainment system, etc.) within a vehicle is typically the center for the radio and other infotainment systems. It is often found in or near the dashboard and includes a user interface (e.g., a touch screen) that an occupant can interact with.

### SUMMARY

One example embodiment provides an apparatus that may include a communication interface, a memory, and a processor coupled to the communication interface and the memory, where the processor configured to establish a link between a mobile device and a head unit within a vehicle, retrieve, by the head unit, one or more data routing tokens from a secure element stored on the mobile device via the link, display identifiers of the one or more data routing tokens on a user interface of the head unit in association with a data exchange, receive an input from the user interface of the head unit which selects a target data routing token from among the one or more data routing tokens, and transmit a request for the data exchange that includes the target data routing token and the data exchange.

Another example embodiment provides a method that includes one or more of establishing a link between a mobile device and a head unit within a vehicle, retrieving, by the head unit, one or more data routing tokens from a secure element stored on the mobile device via the link, displaying identifiers of the one or more data routing tokens on a user interface of the head unit in association with a data exchange, receiving an input from the user interface of the head unit which selects a target data routing token from among the one or more data routing tokens, and transmitting a request for the data exchange that includes the target data routing token and the data exchange.

A further example embodiment provides a computer-readable medium comprising instructions, that when read by a processor, cause the processor to perform one or more of establishing a link between a mobile device and a head unit within a vehicle, retrieving, by the head unit, one or more data routing tokens from a secure element stored on the mobile device via the link, displaying identifiers of the one or more data routing tokens on a user interface of the head unit in association with a data exchange, receiving an input from the user interface of the head unit which selects a target data routing token from among the one or more data routing tokens, and transmitting a request for the data exchange that includes the target data routing token and the data exchange.

One example embodiment provides an apparatus that may include a communication interface, a memory, and a processor coupled to the communication interface and the memory, where the processor configured to generate a plurality of interactions via a head unit of a vehicle, identify a plurality of location data within the vehicle, determine a source vector between the plurality of interactions and the plurality of location data, generate a filtered interaction from the plurality of interactions for the source vector, transmit the filtered interaction to a target user interface from a plurality of user interfaces.

Another example embodiment provides a method that includes one or more of generating a plurality of interactions via a head unit of a vehicle, identifying a plurality of location data within the vehicle, determining a source vector between the plurality of interactions and the plurality of location data, generating a filtered interaction from the plurality of interactions for the source vector, and transmitting the filtered interaction to a target user interface from a plurality of user interfaces.

A further example embodiment provides a computer-readable medium comprising instructions, that when read by a processor, cause the processor to perform one or more of generating a plurality of interactions via a head unit of a vehicle, identifying a plurality of location data within the vehicle, determining a source vector between the plurality of interactions and the plurality of location data, generating a filtered interaction from the plurality of interactions for the source vector, and transmitting the filtered interaction to a target user interface from a plurality of user interfaces.

### BRIEF DESCRIPTION OF THE DRAWINGS

FIGS. 1A-1C are diagrams illustrating a process of an automotive head unit extracting payment information from a connected user device according to example embodiments.

FIGS. 2A-2D are diagrams illustrating a process of executing a payment through an automotive head unit according to example embodiments.

FIGS. 3A-3C are diagrams illustrating a process of a head unit interacting with a payment card network to pre-authorize a transaction according to example embodiments.

FIGS. 4A-4F are diagrams illustrating a process of displaying payment data within a vehicle based on a location of the occupant that placed an order according to example embodiments.

FIG. 4G-4I illustrates an Artificial Intelligence (AI)/Machine Learning (ML) network diagram for integrating an artificial intelligence (AI) model into any decision point in the example embodiments.

FIG. 5A is a diagram illustrating a method of transmitting a payment request from an automotive head unit according to example embodiments.

FIG. 5B is a diagram illustrating a method of displaying transaction data in a vehicle based on a location of an occupant involved in the transaction according to example embodiments.

FIG. 5C is a flow diagram according to example embodiments.

FIG. 5D is another flow diagram according to example embodiments.

FIG. 5E is another flow diagram according to example embodiments.

FIG. 5F is another flow diagram according to example embodiments.

FIG. 6 is a diagram illustrating a computing system that may be used in any of the example embodiments described herein.

### DETAILED DESCRIPTION

It is to be understood that although this disclosure includes a detailed description of cloud computing, implementation of the instant solution recited herein is not limited to a cloud computing environment. Rather, embodiments of the instant solution are capable of being implemented in conjunction with any other type of computing environment now known or later developed.

The example embodiments are directed to an automotive head unit (i.e., head unit) that can pair with devices, including mobile devices, and the like. In some embodiments, the head unit is an infotainment system that may include a unified hardware interface including screens, buttons, and controls for numerous integrated information and entertainment functions. In some embodiments, the user interface may include a “touch screen” where a user can use a finger or other input mechanism to touch the controls and submit commands to the infotainment system such as turning up the radio, etc.

According to various embodiments, the head unit may pair with a mobile device. As an example, the mobile device may pair with the head unit using a wireless network connection such as Bluetooth. In this example, the mobile device and the head unit are both Bluetooth compatible and allow for a seamless discovery and a pairing process that usually involves a user input on at least one of the head unit and/or the mobile device. As another example, the mobile device may be “plugged into” the head unit by a universal serial bus (USB) cable or the like.

When paired with the mobile device, the head unit may extract account data (e.g., one or more charge cards or payment cards, etc.) from a digital wallet of the mobile device. The extracted account data may be displayed on the user interface of the head unit where a user can interact with and even select a charge/payment card. The digital wallet may include one or more charge/payment cards (e.g., debit card, credit card, gift card, cash card, etc.) which have been digitized and stored within a secure element on the mobile device. The head unit may extract account information including one or more of a name or a cardholder assigned to the card, a card account number, an expiry, a security code, and the like.

In one embodiment, the charge card is a data routing token which may be similar to a charge card. A data routing token may be assigned additional values that can be associated with a particular route, but don't affect the process of URL matching or generation at all. In alternate embodiments, the charge card may be a payment facility. A payment facility is an entity that is associated with multiple types of payment methods.

The one or more charge/payment cards extracted from the digital wallet on the mobile device may be presented/displayed via the user interface of the head unit enabling a user to select a charge/payment card from the digital wallet without ever opening the digital wallet on the mobile device. Therefore, rather than interact with a small screen of a mobile device, while in a moving vehicle, the head unit enables a user/occupant of the vehicle to view the card data on its user interface where the screen and the input mechanisms are larger and easier to use.

The charge/payment card data may be used by the head unit to execute a disbursement transaction through an electronic payment network. For example, the head unit may extract charge/payment card data from a mobile device and receive approval to use an extracted charge/payment card from a user input on the user interface of the head unit. The head unit may also communicate with merchants (e.g., electronic payment systems) such as restaurants, toll booths, grocery stores, doctors' offices, bill paying systems, and the like, over a computer network, to enter into sales transactions based on commands entered by a user on their paired mobile device and/or the user interface of the head unit.

In some embodiments, the vehicle may include multiple occupants who place an order for a good or a service with a service provider (e.g., drive thru, restaurant, bill pay, toll booth, etc.) from the vehicle. As an example, a person may be speaking their order aloud and the head unit may record it and send it to a merchant. As another example, the person may be speaking out the window to a drive thru merchant. In either scenario, the head unit may connect to the merchant's payment system over a computer network. Typically, such an interaction is performed by a driver or front seat passenger. In contrast, in the example embodiments, the vehicle connects to the service providing merchant through the head unit.

In addition, the head unit can interact with sensors installed within the vehicle (e.g., microphones, cameras, seat pressure sensors, etc.) to identify which person in the vehicle is placing the order and where they are located in the vehicle. In response, the head unit can identify a nearest screen in the vehicle and display the payment option for that person on that nearest screen. In some cases, the nearest screen may be a mobile device in the user's hand, pocket, seat, etc. As another example, the nearest screen may be integrated into the vehicle such as within a headrest in the backseat, etc.

Furthermore, the head unit may also detect when multiple users take part in placing an order with a service provider. Here, the head unit may use the sensor data to separate the order into multiple parts corresponding to the multiple occupants who participated in placing the order. The separated order may enable users to pay for only their share of the order. For example, the head unit may detect a first order from a first occupant, and then a second order (in sequence) from a second occupant, etc. Here, the head unit can use the sensors to identify what each occupant ordered and display separate bills for each of the first and second occupants. The payment process may be repeated for each occupant among the multiple occupants that participated in the order. In some embodiments, the payment screen for the different occupants may be output at the same time, or they may be output in sequence such that only one user submits a payment at a time, depending on implementation.

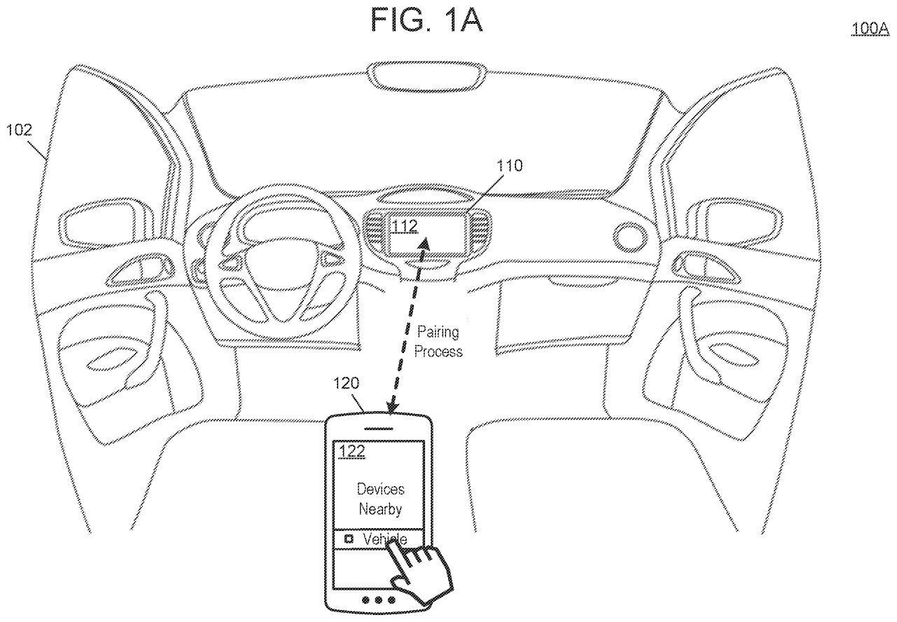

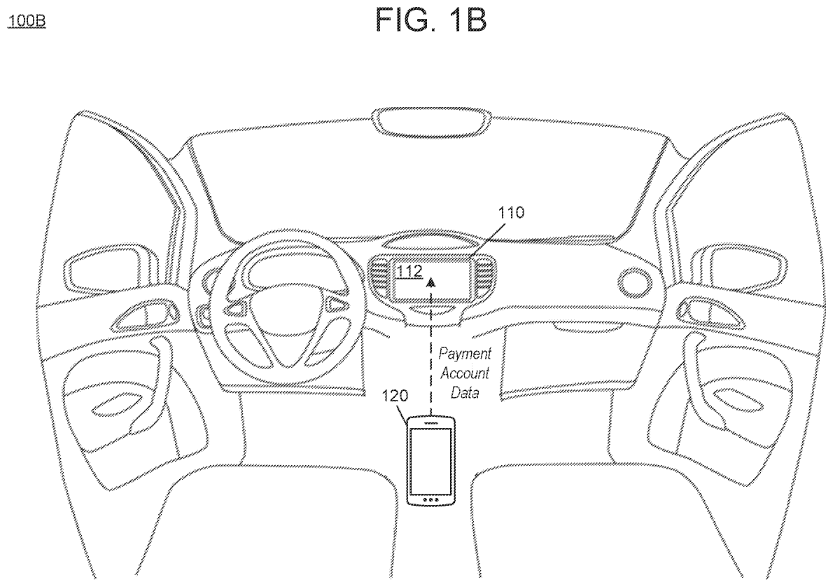

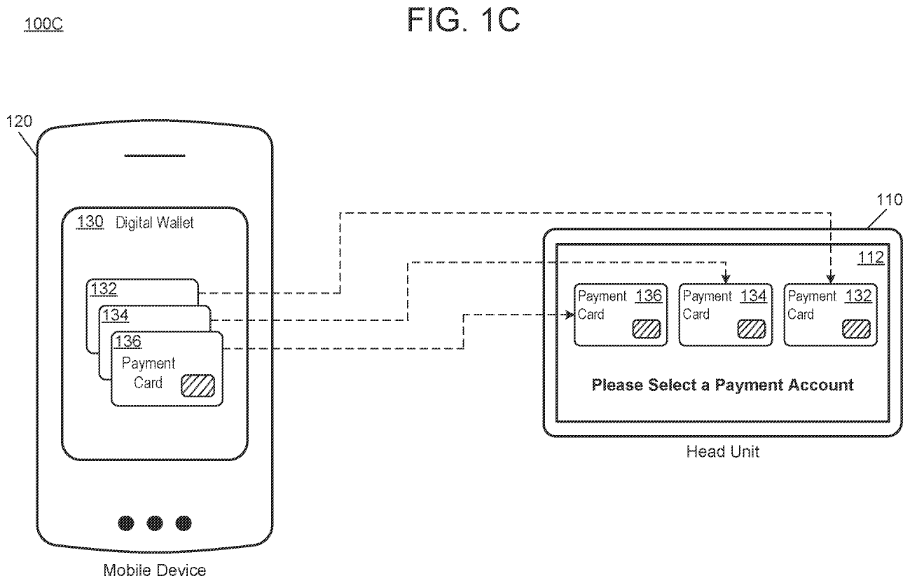

FIGS. 1A-1C illustrate a process of an automotive head unit extracting payment information from a connected user device according to example embodiments. For example, FIG. 1A illustrates a pairing process 100A that is performed between a mobile device 120 and a head unit 110 of a vehicle. For example, the head unit 110 may be an infotainment system or the like with a user interface 112 (e.g., touch screen, etc.) and controls (not shown). The infotainment system may provide services such as radio, navigation, global positioning system (GPS), mapping, and the like. Meanwhile, the mobile device may include a smart phone, tablet, or the like, with a user interface 122 for entering commands. Both the mobile device 120 and the head unit 110 may be Bluetooth enabled and may discover each other through traditional Bluetooth discovery process.

For example, a user may use the user interface 112 of the head unit 110 or the user interface 122 of the mobile device to search for and discover the other device (when nearby) such as when the mobile device 120 is within an interior 102 of a vehicle. In the example of FIG. 1A, the user enters a command into the user interface 122 on the mobile device 120 to select the head unit 110 of the vehicle for pairing. Once paired, software applications, data, contacts, GPS, and the like, installed or otherwise stored on the mobile device 120 may be accessible to the head unit 110 through the established pairing channel.

For example, FIG. 1B illustrates a process 100B of the head unit 110 extracting data from the mobile device 120 through the established pairing channel. As an example, the head unit 110 may automatically detect a digital wallet installed on the mobile device 120 in response to the mobile device 120 being paired with the head unit 110. The head unit 110 may extract payment account data that is stored/held in the digital wallet on the mobile device 120 and display the payment account data on the user interface 112 of the head unit. Here, a user can use the head unit 110 to make payments using charge/payment cards stored in the digital wallet on the mobile device 120 without having to open the digital wallet or even use the mobile device 120. Instead, the entire process may be performed through the head unit 110.

For example, a user may connect to a service provider that sells goods and/or services via the head unit 110 for the purpose of purchasing an item. For example, the user may enter a site or address of the service provider into a search bar on the user interface 112 of the head unit 110. As another example, the user may access a website of the service provider using the mobile device 120 which is then displayed on the user interface 112 of the head unit 110. During this process, the head unit 110 and/or the mobile device 120 may access an application programming interface (API), a storage, or the like, of the service provider and retrieve a list of products (e.g., items, goods, services, etc.) that can be purchased by users that are currently in the vehicle.

A user may select a product or perform some other activity to select an item for purchase from the service provider. When the user determines to checkout, the service provider may output a payment screen on the user interface 112 of the head unit 110. Here, the head unit 110 can also display identifiers of one or more charge/payment cards from the digital wallet on the mobile device 120 that have been extracted by the head unit 110. The user can thus use any of the charge/payment cards from the digital wallet by simply interacting with the card data via the user interface 112 of the head unit 110.

For example, FIG. 1C illustrates a process 100C of the head unit 110 outputting identifiers of a plurality of charge/payment cards via the user interface 112 of the head unit. Here, the head unit 110 extracts payment account data of a payment card 132, a payment card 134, and a payment card 136 from a digital wallet 130 installed on the mobile device 120. The head unit 110 displays identifiers of the payment cards with selectable controls that can be used by the user to select a payment card for purchasing the item.

As further described herein, the head unit 110 may transmit the payment information to a payment terminal of the service provider. As another example, the head unit 110 may interact directly with a charge/payment card network. In this example, the head unit 110 may add the payment information to a disbursement authorization request message and transmit the disbursement authorization request message to a payment processer on an electronic payment network.

According to various embodiments, when the head unit and the mobile device are paired together, the occupant of the vehicle may use the head unit to make payments using the charge/payment cards stored in the mobile device. In some embodiments, the user interface of the head unit may be used as a biometric reader or fingerprint reader for purposes of validating the user of a charge/payment card. As another example, a multi-factor authentication (MFA) may be performed on the mobile device that involves a personal identification number (PIN), password, biometric reading, etc. For example, the head unit may determine whether to use multi-factor authentication, biometric authentication, etc. based on a size/amount of the transaction. If the transaction is above a predetermined threshold (e.g., $100), the head unit may perform the MFA.

As another example, a computer/processor within the vehicle may determine a destination of the vehicle as the vehicle is travelling. This may be performed using artificial intelligence (AI), machine learning (ML), etc. based on the route traveled so far by the vehicle. The computer may identify an item (e.g., a good, service, etc.) at the predicted destination and may pre-authorize a payment transaction for purchasing the item. The vehicle computer may determine the cost of the good/service. As another example, the vehicle may use a predetermined order with an associated cost. Furthermore, the head unit may receive the cost and pre-authorize a transaction for the item without a user requesting the pre-authorization and before the vehicle reaches the destination.

In some embodiments, the head unit may execute a portion of the transaction when the vehicle arrives at the destination. The remaining portion may be executed by the head unit upon leaving the destination and when the system validates that the good/service was received. The solution may utilize sensors on the vehicle for validation (e.g., cameras, microphones, radar, etc.). The vehicle may also connect with other servers (e.g., businesses) for further validation. The system may perform the transaction utilizing pre-authorization, pre-pay, post-pay, and money movement protocols.

In one embodiment, the instant solution can initiate and authenticate payment transactions using the user's voice. The instant solution uses a voice-controlled interface in the vehicle's head unit to allow users to initiate and authenticate payment transactions using voice commands. It incorporates advanced voice recognition technology focusing on identifying the specific voice characteristics of the user, akin to a biometric verification system. The instant solution recognizes both the content of the spoken words and the unique voice patterns of the registered user, such as tone, pitch, and speaking style. This ensures that payment commands are only accepted from authorized users, enhancing security. For added security, the instant solution can require the user to speak a predetermined passphrase or answer a personalized security question set up during the system initialization. The user can initiate a transaction by speaking a command, such as “Pay for my coffee” or “Initiate payment to [Service Provider].” The instant solution processes the command by accessing the digital wallet linked to the mobile device. Following the initiation command, the system can ask for a voice-based passphrase or a response to a security question. This step is crucial for verifying the identity of the speaker. Once the voice is authenticated, the instant solution confirms the transaction details, including the payee and the amount. The user authorizes the transaction verbally. The digital wallet on the user's mobile device is synchronized with the vehicle's head unit. When a payment command is issued, the head unit accesses the wallet to extract payment details. The instant solution is also integrated with the vehicle's GPS and infotainment systems to provide context-aware services. For example, if the vehicle is near a known vendor (like a coffee shop), the instant solution can prompt the user if they would like to make a usual purchase.

In one embodiment, the instant solution utilizes AI and ML to analyze various factors such as the vehicle's current location, time of day, past purchasing history, and user preferences to offer personalized and contextually relevant purchase suggestions. The instant solution uses the vehicle's GPS and onboard sensors to determine its location and movement patterns. Time of day and calendar data are integrated to understand user routines and preferences. Additionally, past transaction data from the digital wallet is analyzed to recognize purchasing habits and preferences. Based on the analyzed data, the AI system generates context-specific purchase suggestions. For instance, if the vehicle is near a user's favorite coffee shop in the morning, the system might suggest ordering their usual coffee. The suggestions are displayed on the head unit's interface or communicated via the vehicle's audio system. Upon user confirmation, the system automatically initiates the transaction through a simple voice command or a button press. It connects to the service provider's online platform via an internet connection, places the order, and processes the payment through the user's digital wallet. The head unit displays contextual suggestions with simple, intuitive controls for user confirmation. The system can also accept voice commands for a hands-free experience. The instant solution integrates with various online platforms and service providers. Users can set preferences for the types of suggestions they want to receive and opt out of specific suggestions or disable the feature entirely.

In one embodiment, the instant solution allows users to shop and arrange for the delivery of items directly to their vehicle, regardless of their location. The instant solution involves advanced coordination between the vehicle's head unit, the user's digital wallet, and delivery services. Users can browse and shop using the head unit's interface, which connects to various online retailers and service providers. Once the user selects an item, they choose an “In-Vehicle Delivery” option at checkout. The payment is processed through the digital wallet linked to the user's mobile device, ensuring a seamless transaction. Upon order confirmation, the instant solution generates a secure, one-time access code for the vehicle. This code is shared with the delivery service but remains encrypted and time-bound for security. The delivery person uses the one-time code to unlock the vehicle and place the item inside. The code works only within a predefined time window around the estimated delivery time. The instant solution records the delivery event, including time and a photo or video for confirmation, ensuring the user is informed and the delivery is documented. The user receives real-time updates on their mobile device or via the vehicle's head unit about the delivery status. The interface allows tracking the delivery, viewing the delivery confirmation, and remotely monitoring the delivery process via the vehicle's cameras. Post-delivery, the instant solution re-secures the vehicle and notifies the user. The instant solution allows users to set preferences for delivery, such as preferred delivery times, specific vehicle locations, and instructions for delivery personnel.

In one embodiment, the instant solution introduces dynamic, usage-based insurance rates. It leverages data gathered from the vehicle's sensors and systems to calculate insurance costs tailored to specific journeys or driving patterns, with payments processed directly through the linked digital wallet. The instant solution collects data on driving behavior (like speed and braking patterns), location, distance traveled, and time of day. The data is analyzed to assess the risk level associated with each journey or driving period. Using algorithms, the instant solution calculates the insurance cost in real-time or over a predefined period based on the analyzed data. Factors such as frequent hard braking, high-speed driving, or driving in high-risk areas influence the cost. The instant solution is linked to the user's insurance provider. It communicates the calculated risk and associated insurance rate to the provider for real-time adjustments to the insurance premium. Once the cost is calculated and communicated, the payment for the insurance is automatically processed through the user's digital wallet. The transaction details, including the insurance coverage period and cost, are displayed on the head unit, and can be sent to the user's mobile device. The head unit's interface provides detailed reports of driving behavior, risk assessments, and the corresponding insurance costs. Users can access historical data to understand their driving patterns and potential areas for cost savings. The instant solution ensures the security of data transmission and financial transactions through encryption and other cybersecurity measures.

In one embodiment, the instant solution streamlines contacting and paying for emergency services or roadside assistance directly from a vehicle. In the event of a vehicle breakdown, accident, or other emergencies, the vehicle's head unit can connect with the necessary services immediately, and the payment for these services is automatically processed through the digital wallet linked to the user's mobile device. The head unit has a dedicated interface for emergency and roadside assistance services. It can automatically detect a vehicle breakdown or collision using the vehicle's sensors and systems. In an emergency, the driver uses the head unit to contact the required services, such as towing, repair, medical assistance, or police. The vehicle's system automatically alerts these services in certain situations, like airbag deployment. Once a service is requested, the instant solution estimates the cost based on predefined rates or real-time quotes from service providers. The payment is automatically processed through the digital wallet, with all transaction details displayed on the head unit. The interface includes visual and auditory cues to guide users through contacting services and confirming payments. The instant solution uses encryption for all data transmissions. The instant solution automatically shares the vehicle's location with emergency services for a faster response. It notifies emergency contacts and provides real-time updates on the situation.

In one embodiment, the instant solution integrated with a system within a vehicle facilitates seamless and secure payment transactions through an integrated system. The system comprises three key components: a communication interface, a memory unit, and a processor. The communication interface is the component for establishing a reliable channel between a mobile device and the vehicle's head unit, which is embedded within the vehicle. The head unit is an infotainment system with a user-friendly interface, possibly a touchscreen. It interacts with the vehicle occupant's mobile device. The head unit and the mobile device are Bluetooth-enabled and paired through a standard Bluetooth discovery process. The process is initiated through the head unit's interface or the mobile device, enabling a connection when the mobile device is inside the vehicle. Once paired, the head unit accesses the mobile device's digital wallet application. The instant solution retrieves charge/payment card information stored in the digital wallet on the mobile device through the established Bluetooth channel. After retrieving the information, the instant solution displays the identifiers of one or more charge/payment cards on the head unit's user interface, allowing the vehicle occupant to select a preferred charge/payment card for a transaction. Upon user selection of a charge/payment card, the instant solution transmits an authorization request. The request is sent from the head unit to the selected charge/payment card issuing system over a computer network for the payment activity.

In one embodiment, the instant solution, after sending an authorization request for a transaction, is equipped to handle the response from the charge/payment card's issuing system. The instant solution is configured to receive the authorization response from the issuing system via a secure computer network. Upon receiving the authorization from the issuing system, the instant solution executes the disbursement process. The execution involves using the selected charge/payment card for the identified activity or purchase. It consists of communications and data exchanges between the vehicle's head unit, the mobile device, and the external payment systems. Additionally, it includes verifying transaction details, finalizing the payment amount, and transferring funds from the user's account to the service provider's account. The instant solution displays the charge/payment card information on the head unit's user interface, allowing users to provide feedback about the transaction status. For example, once the authorization is received, the user interface might display a confirmation message, indicating that the transaction is being processed or completed.

In one embodiment, the instant solution, after receiving input from a user via the head unit's interface selecting a charge/payment card from the ones available, initiates a pre-authorization process. The instant solution is configured to recognize and respond to the user selecting a charge/payment card for a particular transaction. Upon this recognition, the instant solution communicates with the selected charge/payment card issuing system over a computer network to initiate a pre-authorization process for the payment of the activity or purchase the user intends to make. The pre-authorization verifies the transaction and reservation of funds before the actual transaction is completed, ensuring that the funds are available and minimizing the risk of transaction failure due to insufficient funds or other financial issues. The instant solution transmits relevant transaction details to the charge/payment card's issuing system during pre-authorization. The details include the transaction amount, the payee's identity, and other pertinent information required for pre-authorization. Upon receiving these details, the issuing system verifies the availability of funds and reserves the specified amount for the transaction. The reservation is then communicated back to the processor via the same network. Once the pre-authorization is confirmed, the user interface of the head unit displays a notification or status update. The pre-authorization process can involve additional security checks, including encryption of the data transmitted over the network and secure handling of the transaction details within the head unit's memory.

In one embodiment, the instant solution pairs a mobile device to a vehicle's head unit through a Bluetooth channel to allow for payment transactions. The system integrated with the instant solution comprises a communication interface, a memory unit, and a processor. The system is specially configured to facilitate and manage the Bluetooth pairing process between the mobile device and the head unit of the vehicle. The process begins when the vehicle's occupant attempts to establish a connection between their mobile device and the vehicle's head unit. Both the mobile device and the head unit are equipped with Bluetooth capabilities. The pairing process is initiated by either the user interface of the head unit or the mobile device, depending on which device the user chooses to start the pairing. Once the pairing process is initiated, the Bluetooth modules in both the head unit and the mobile device enter discovery mode, searching for compatible devices within their range. Upon discovering each other, a secure Bluetooth channel is established between the head unit and the mobile device. The user confirms the connection on either or both devices, adding a layer of security to prevent unauthorized connections. Once the pairing is successful, the head unit, through the established Bluetooth connection, gains access to certain functionalities of the mobile device, allowing it to retrieve charge/payment card information from the digital wallet installed on the mobile device.

In one embodiment, the instant solution implements a multi-factor authentication (MFA) process on a vehicle payment transaction. Once a user selects a charge/payment card using the head unit's interface for a transaction, the instant solution initiates an MFA request. The instant solution sends a prompt to the user's mobile device, connected to the head unit via Bluetooth. The prompt appears as an MFA window on the mobile device, requesting user authorization for the selected charge/payment card. The MFA request may involve various forms of user validation, such as entering a password or PIN or providing a biometric input like a fingerprint or facial recognition. Upon receiving the user's validation input, the mobile device sends the data back via the established Bluetooth connection. Upon receiving the validation data, the instant solution verifies it against the pre-stored credentials or reference biometric data in the memory unit. This step is crucial to ensure that the authorized user of the mobile device and the associated charge/payment card initiate the payment process. Once the validation is successful, the instant solution transmits the authorization request from the head unit to the charge/payment card issuing system over a computer network. The transmission sends details of the transaction along with the confirmed user authentication. The user interface of the head unit displays the payment card information for the selection and provides feedback about the status of the MFA process. For instance, it may display a message indicating that additional authentication is required and subsequently confirm the successful completion of the MFA process.

In one embodiment, the instant solution uses a biometric input as part of a multi-factor authentication (MFA) process during a vehicle payment transaction. The system integrated with the instant solution includes a communication interface, a memory unit, and a processor. The processor is specifically programmed to manage and authenticate biometric inputs as part of the transaction process. When a user initiates a payment transaction through the head unit's interface, the processor triggers an MFA process that includes a biometric authentication step. The biometric authentication process starts with the instant solution sending a request to the user's mobile device, which is connected to the head unit via a secure Bluetooth channel. The request prompts the MFA window on the mobile device to collect a biometric input from the user. The nature of this biometric input can vary, including options like fingerprint scanning, facial recognition, or iris scanning, depending on the capabilities of the mobile device. Once the user provides biometric input on the mobile device, the data is securely transmitted back to the head unit via Bluetooth. Upon receiving the biometric input, the instant solution compares the input with a reference biometric input previously stored in the memory unit. The comparison is crucial for verifying the user's identity and ensuring that the legitimate owner of the charge/payment card and mobile device authorizes the transaction. When the biometric input matches the stored reference, the instant solution confirms the user's identity and proceeds with the payment transaction process, transmitting the authorization request from the head unit to the charge/payment card's issuing system over a computer network. The user interface of the head unit displays the charge/payment card information for user selection, communicates the biometric authentication, and provides feedback on the authentication status.

In one embodiment, the instant solution identifies potential destinations and items of interest for purchase, integrating the information with an in-vehicle payment process. The instant solution analyzes the vehicle's current route and driving patterns to predict its destination. The prediction considers various factors, including the vehicle's GPS data, previously visited locations, and typical travel habits of the user. Once a destination is identified, the instant solution accesses a database, stored in the memory unit, or possibly retrieved from an external source via a network connection, to identify items of interest related to the destination. The items are tailored to the user's preferences or past purchasing behavior. For example, the processor might display available items if the vehicle is heading toward a shopping center. The identified items, along with their details, are displayed on the user interface of the head unit. The interface shows charge/payment card information and includes identifiers of the potential items of interest. The user can interact with the interface to learn more about these items and select them for purchase. The instant solution initiates the payment transaction process when the user selects an item. The payment process retrieves charge/payment card information from the user's digital wallet on their mobile device, including authorization and final payment execution. A Bluetooth connection facilitates the communication between the head unit and the mobile device.

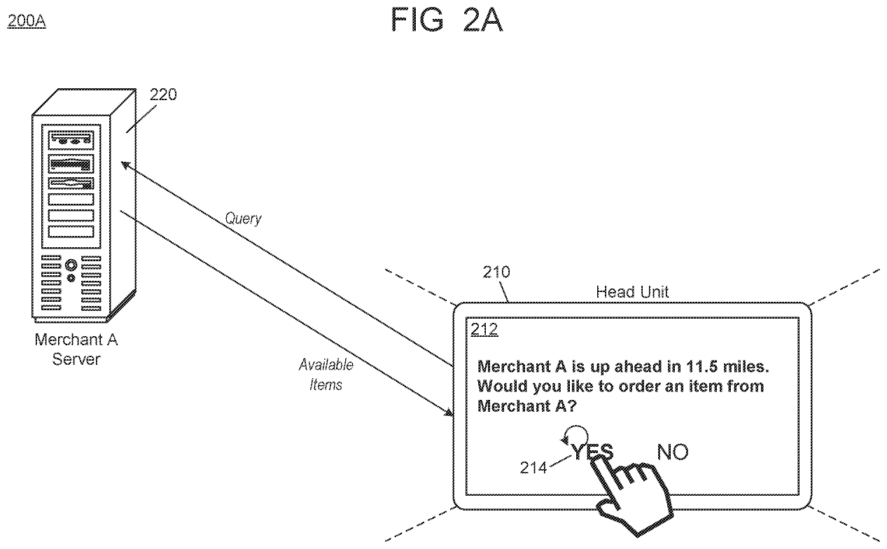

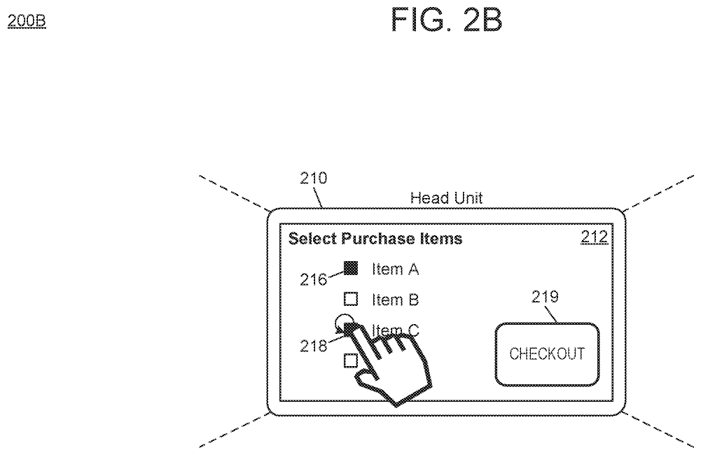

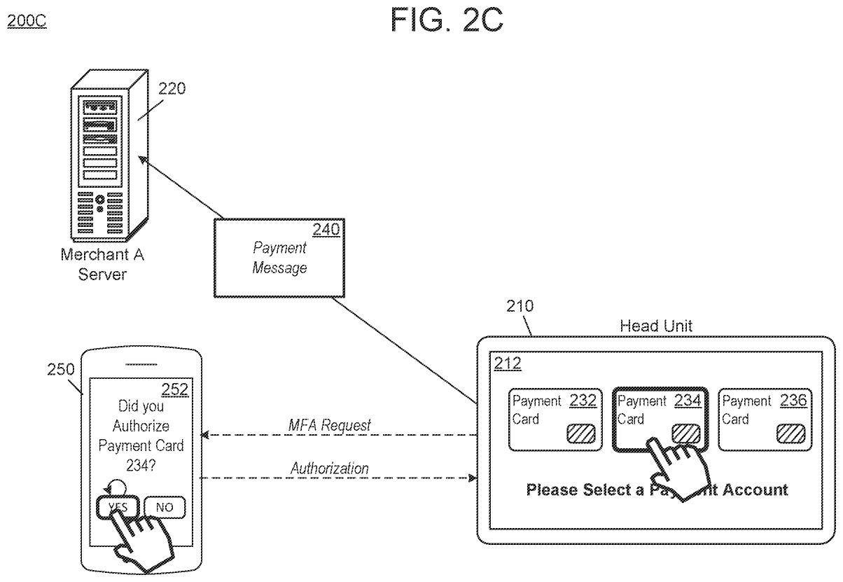

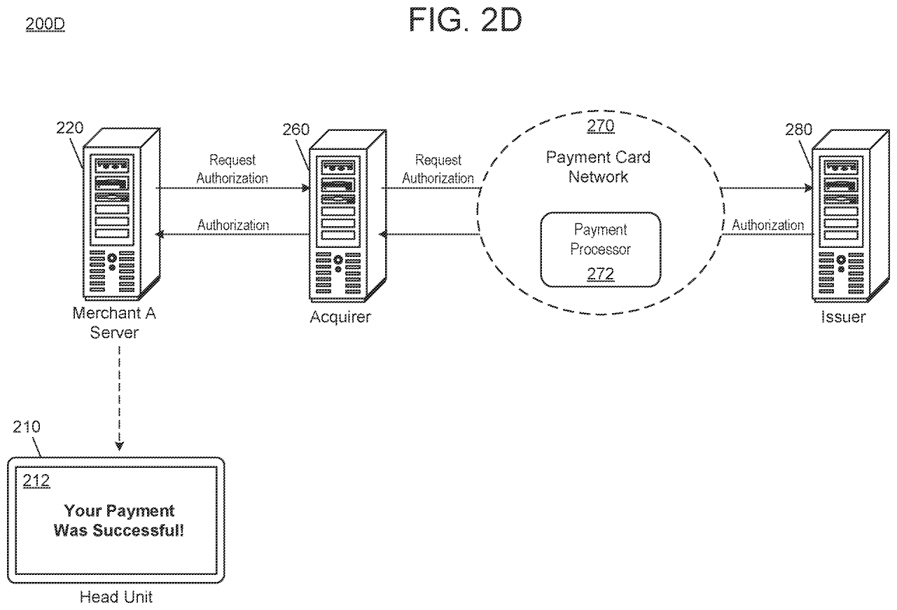

FIGS. 2A-2D are diagrams illustrating a process of executing a payment through an automotive head unit according to example embodiments. For example, FIG. 2A illustrates a process 200A of a head unit 210 within a vehicle (not shown) querying a server 220 of a service provider/merchant. In this example, the head unit 210 may query the server 220 for a list of items, products, services, etc., which can be purchased by an occupant within the vehicle. Here, the head unit 210 may notify the occupant(s) of the opportunity to purchase an item from the service provider on a user interface 212 of the head unit 210.

In the example of FIG. 2A, the head unit 210 displays a notification on the user interface 212 along with control buttons which the user can select to place an order. In this example, the user presses on a button 214 on the user interface 212 of the head unit 210 to view a list of items that can be purchased from the service provider. Here, the list of items is provided by the server 220 of the service provider to the head unit 210.

By selecting the button 214 shown in FIG. 2A, the head unit 210 displays a list of items on the user interface 212 as shown in the example of FIG. 2B. Here, FIG. 2B illustrates a process 200B of a user making selections of items via the user interface 212 of the head unit 210. The user may use their finger or other input mechanism and select control elements 216 and 218 on the user interface 212 corresponding to two different items available for purchase to thereby select products and/or services for purchase. In some embodiments, the user may select more than one item. When the user is ready to checkout, the user may press another button (e.g., checkout button 219, etc.) on the user interface 212.

FIG. 2C illustrates a process 200C of executing a payment transaction via the head unit 210 of the vehicle according to example embodiments. Referring to FIG. 2C, the head unit 210 may display a payment option screen on the user interface 212 of the head unit 210 in response to the user deciding to checkout. In this example, the payment option screen provides a choice of three payment options for the user to choose from. Here, the payment options are extracted from a mobile device 250 of an occupant of the vehicle, such as from a digital wallet installed on the mobile device 250. The head unit 210 may display identifiers of the payment options on the user interface 212 including a first payment option 232, a second payment option 234, and a third payment option 236. The user may select one of the payment options, for example, the second payment option 234. In response, the head unit 210 may carry out a payment transaction.

In some embodiments, the head unit 210 may perform the payment transaction with the server 220 without additional verification or validation. Here, the head unit 210 may submit payment account data of the second payment option 234 in a payment message 240 to the server 220 to execute a payment transaction to purchase the items selected in FIG. 2B. As another example, the head unit 210 may perform an additional verification before executing the payment. As an example, the head unit 210 may perform a multi-factor authentication process with the mobile device 250.

The head unit 210 may display a request on a user interface 252 of the mobile device 250 which requires user input to validate the payment using the selected payment card. In some embodiments, the validation may be performed by simply clicking on a button or other element. As another example, the user may be required to provide biometric scan (e.g., iris, fingerprint, face, etc.) via the user interface 252 and/or a camera (not shown) of the mobile device 250. The payment process may be carried out with the server 220 via an electronic payment card network.

For example, FIG. 2D illustrates a process 200D of the server 220 executing a payment process for the purchase of the items using the selected payment account received from the head unit 210 of the vehicle. Here, the server 220 may send a payment authorization request message to an acquirer (server of an acquiring bank of the merchant) with the payment credentials of the selected payment card including the account number, expiry, security code, name, etc. The acquirer may execute the payment through an electronic payment card network 270. During this process, a payment processor 272 may receive the payment authorization request message from the acquirer and verify the payment information and enough balance in the account with an issuer 280 that issued the selected payment card.

The payment processor 272 may receive authorization from the issuer 280 and forward it to the acquirer 260 thereby processing the payment. The acquirer 260 may forward the notice of authorization to the server 220 to complete the payment. Furthermore, the server 220 may display a notification on the user interface 212 of the head unit 210 to indicate that the payment was processed successfully. The payment process performed in FIG. 2D relies on the server 220 of the merchant to execute the payment via the payment card network. However, as another option, the head unit may interact directly with the payment card network without transmitting the payment data to the server of the service provider.

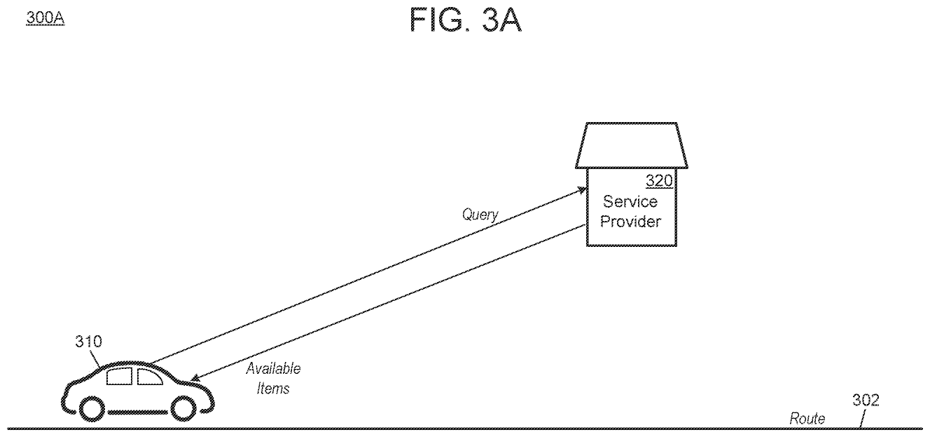

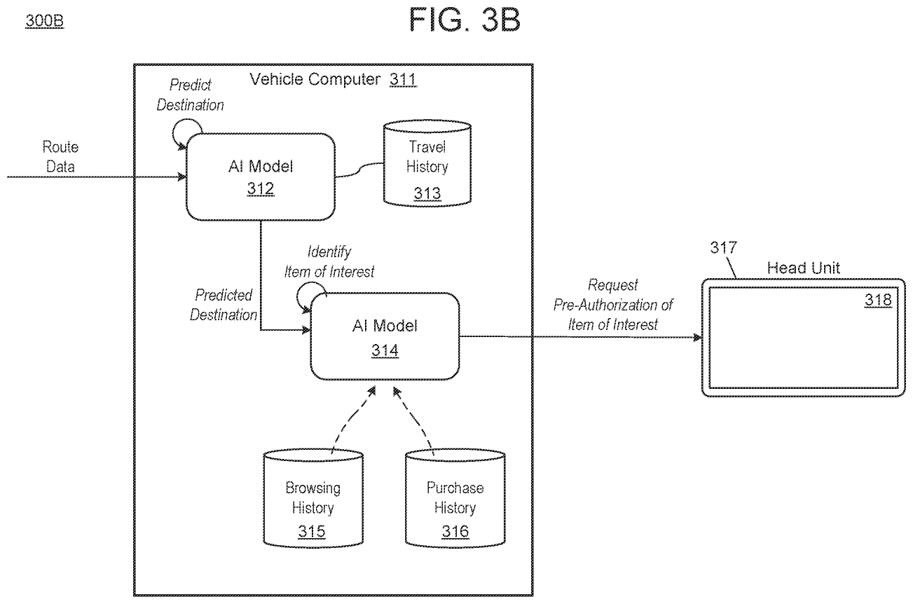

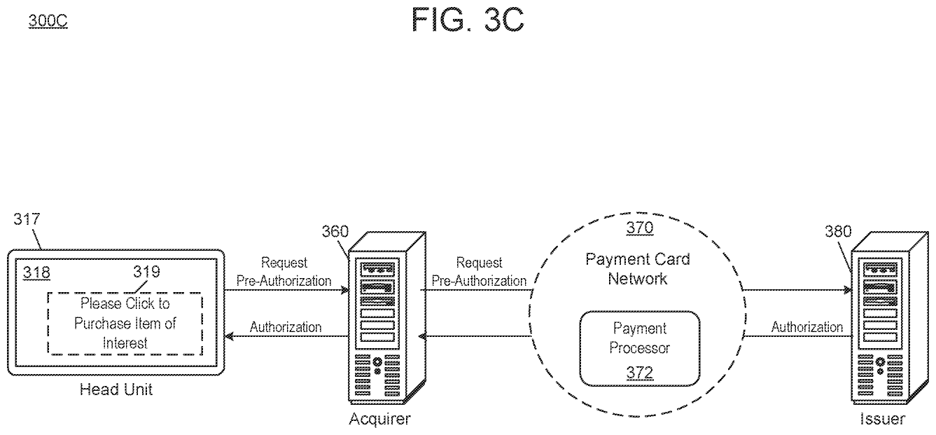

FIGS. 3A-3C illustrate a process of a head unit acting as a payment gateway to pre-authorize a transaction according to example embodiments. For example, FIG. 3A illustrates a process 300A of a vehicle 310 travelling along a route 302 and FIG. 3B illustrates a process 300B of a vehicle computer 311 predicting a destination of the vehicle and identifying an item of interest at the predicted destination. In some embodiments, the route 302 (shown in FIG. 3A) may be a planned route that is entered into a navigation system or other system within the vehicle that is connected to a head unit 317 of the vehicle (shown in FIG. 3B). According to various embodiments, the vehicle computer 311 (shown in FIG. 3B) can predict a destination of the vehicle 310 (shown in FIG. 3A) based on the part of the route 302 that has been travelled so far by the vehicle 310.

For example, referring to FIG. 3B, the vehicle computer may include an artificial intelligence (AI) model 312 that can receive the route travelled by the vehicle 310 (shown in FIG. 3A) so far and predict a final destination of the vehicle 310 based on the route travelled (partial route) and historical travel routes stored in a travel history database 313. In this example, the predicted destination is a geographic point that is near a service provider 320 (shown in FIG. 3A). The predicted destination may be input to another AI model 314 to predict an item of interest to the occupant of the vehicle based on historical browsing history stored within a browsing history database 315 and purchase history data stored in a purchase history database 316. The historical browsing and purchase data may include geographic information about the location of various items which can be identified by the AI model 314.

In this example, the AI model 314 may determine an item of interest is located at the service provider 320 (shown in FIG. 3A) and send a request to the head unit 317 to pre-authorize a payment transaction for the item of interest. Here, the user may agree by selecting an input on a user interface 318 of the head unit 317. As another example, the pre-authorization may be performed automatically without a need for approval from the occupant. In response, the head unit 317 may execute a payment transaction via an electronic payment card network. For example, FIG. 3C illustrates a process 300C of the head unit 317 sending a payment pre-authorization request message to an acquirer 360 of a merchant/service provider of the item of interest. In this example, the head unit 317 bypasses the merchant server and transmits the payment pre-authorization request message to the acquirer 360 directly.

In response, the acquirer 360 executes a payment processor with an issuer 380 of a payment card that is pre-authorized for such transactions by the cardholder occupant. The pre-authorization may be performed by the cardholder entering commands into the digital wallet at a previous time or in response to a question in real time. Here, a payment processor 372 on the payment card network 370 may execute the payment, verify the payment card, and return a notification of successful authorization to the acquirer 360. The acquirer may deliver a coupon 319 to the head unit 317 which can be used to purchase the item of interest when the occupant arrives at the intended destination. In some embodiments, the coupon 319 may be saved to the digital wallet on the mobile device (not shown) of the occupant and used by the occupant in-person at the service provider location.

In the previous examples, the vehicle is paired with a mobile device, and the mobile device provides payment information for the purpose of performing a payment through the automotive head unit. As another example, the head unit may be connected to a plurality of available display devices including display devices that are integrated into the vehicle, mobile devices of occupants in the vehicle, and the like. These devices may include display devices embedded into the back of vehicle seats, display devices embedded in the dashboard, smart phones, and other user devices in the vehicle, and the like. Each of these devices may be connected to the head unit in some way.

When an occupant within the vehicle interacts with a service provider in an audible/visible manner (e.g., while speaking with an employee of a drive-thru restaurant, etc.), sensors on the vehicle may capture data of the occupant and provide it to the head unit (or vehicle computer). Here, the head unit may use the sensor data to identify a location of the occupant within the vehicle (e.g., front seat, back seat, passenger side, driver side, etc.) and also identify the closest display device to the occupant from among the multiple available display devices. For example, the head unit can present checkout information for the occupant to complete a purchase with the service provider on the closest display device thereby improving the ease and efficiency of the ordering and checkout process.

Furthermore, when multiple occupants participate in the ordering, the head unit can identify which portion of the order corresponds to which occupant. Furthermore, the head unit can split the bill based on the portions identified for the different occupants, and present payment screens to each of the occupants for only their portion of the order. The payment screen may be provided on a nearest display device to each occupant which may differ among the multiple occupants participating in the order. Thus, the head unit can use multiple display devices in the vehicle to enable multiple occupants to split a check/bill and pay their portion.

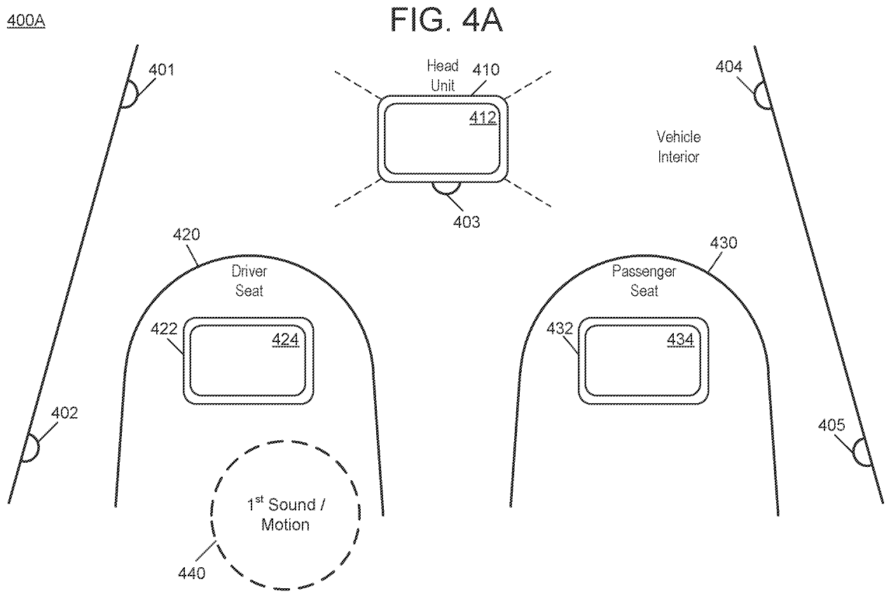

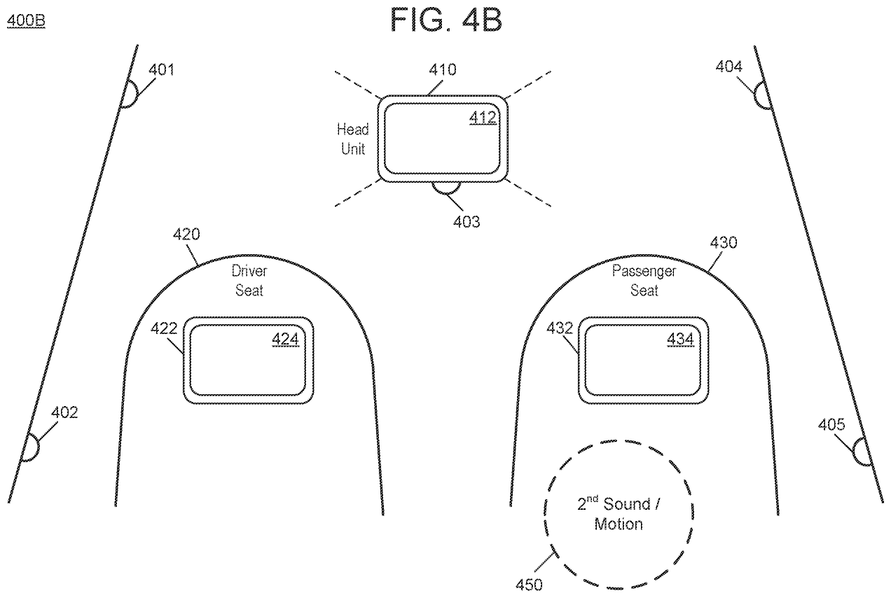

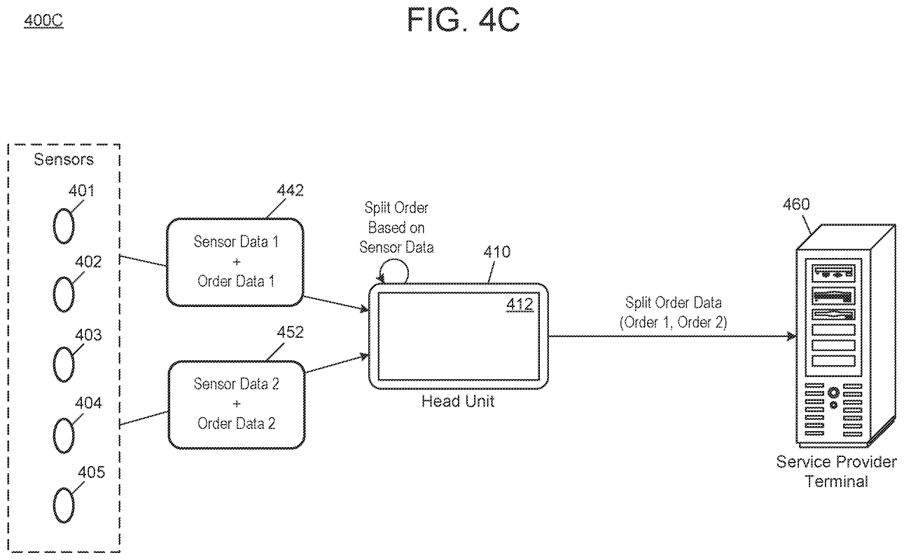

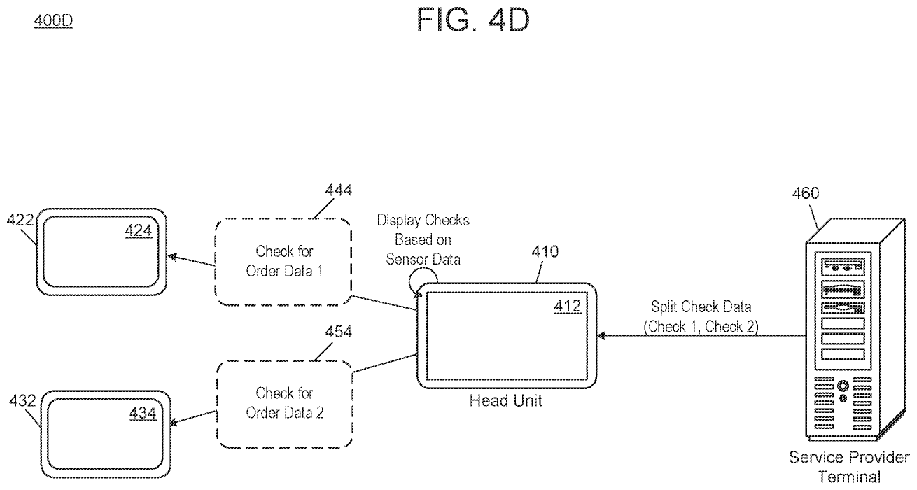

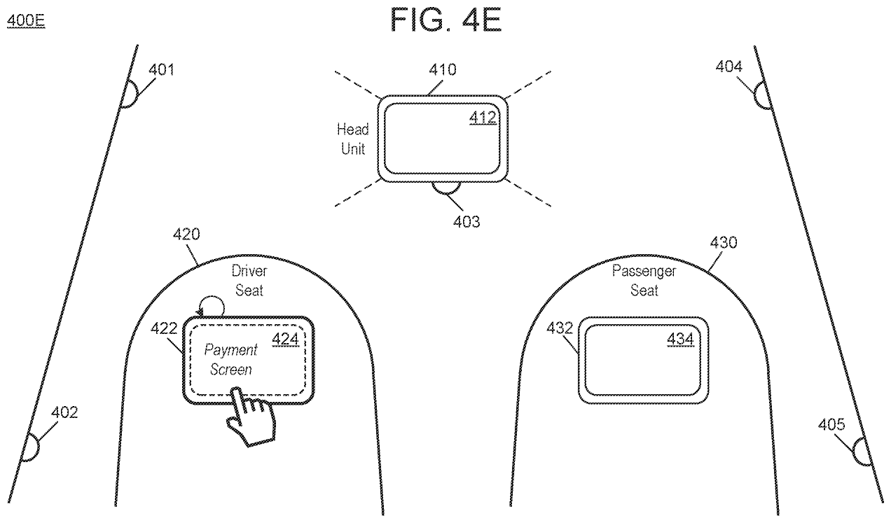

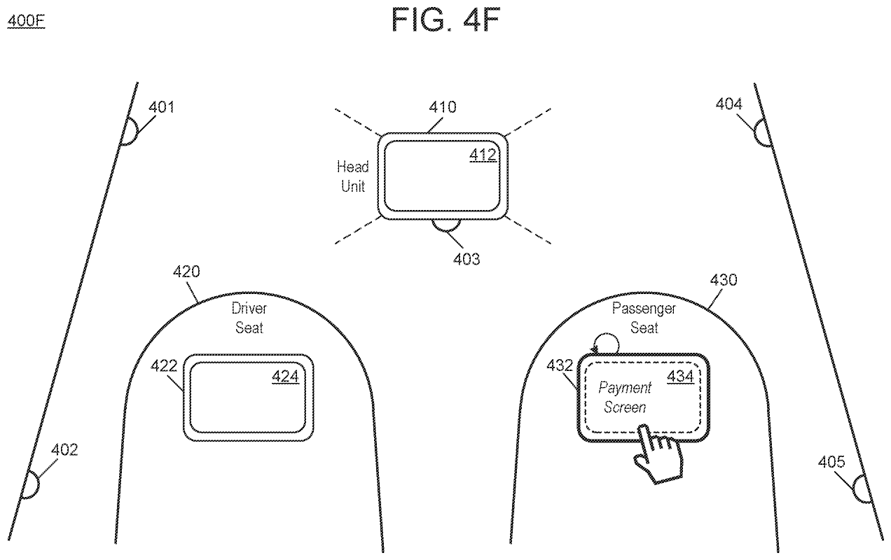

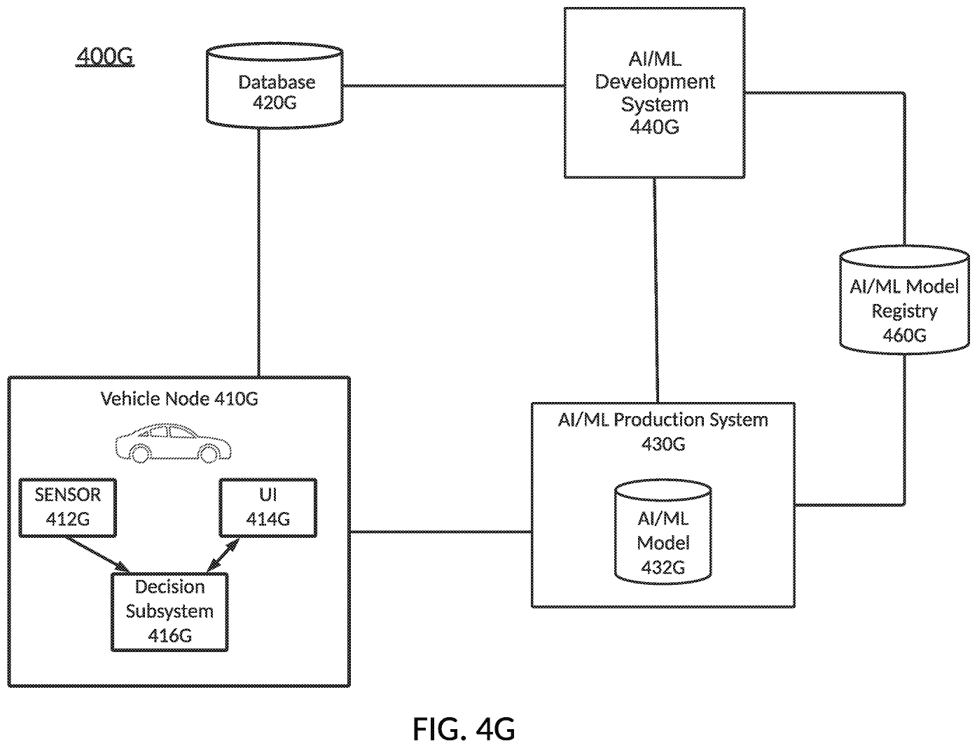

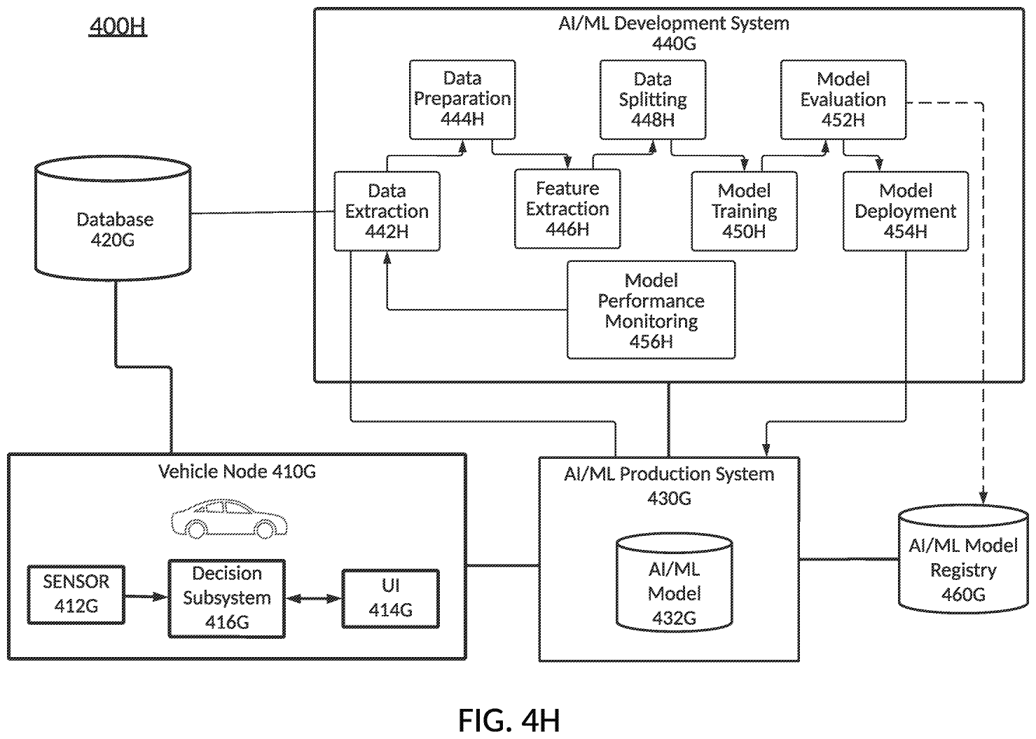

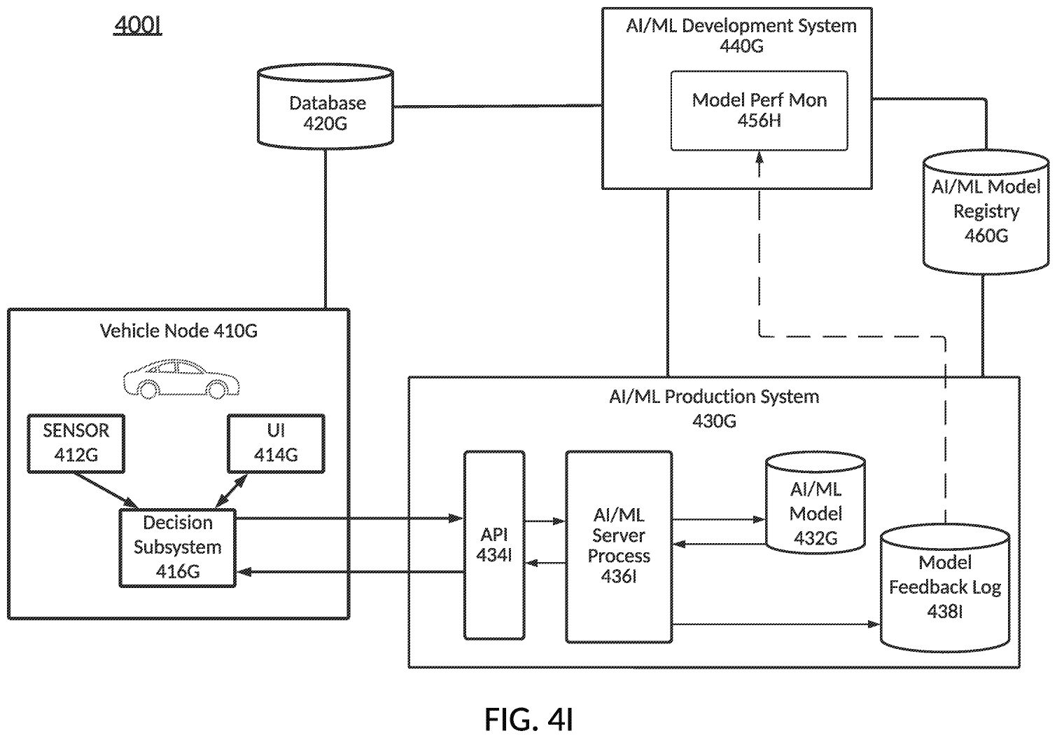

FIGS. 4A-4F illustrate a process of displaying payment data within a vehicle based on a location of the occupant that placed an order according to example embodiments. For example, FIG. 4A illustrates a process 400A of sensors within a vehicle detecting activity performed by a first occupant within an interior of a vehicle that includes multiple display devices. In this example, the vehicle includes sensors 401, 402, 403, 404, and 405 which are installed within the vehicle interior and which can capture movement, audio, temperature, pressure, etc. The vehicle also includes multiple display devices including a head unit 410, a display device 422 embedded in the rear of a driver seat 420, and a display device 432 embedded in a rear of a passenger seat 430 of the vehicle.

According to various embodiments, the head unit 410 may connect to a service provider, for example, based on inputs to a user interface 412 of the head unit 410. When connected, the head unit 410 may activate the sensors 401, 402, 403, 404, and 405 to capture audio, video, pressure, etc. of occupants within the vehicle. As such, the head unit 410 can be communicably connected to a service provider computing terminal (e.g., wirelessly), communicably connected to one or more mobile devices in the vehicle (e.g., via Bluetooth), communicably connected to one or more display modules in the vehicle in a wired fashion, and the like.

In the example of FIG. 4A, a first occupant places an order with a service provider and one or more of the sensors capture audio and/or motion from a location 440 within the interior of the vehicle of the first occupant placing the order. The audio may be captured by a microphone, etc. and the motion may be captured by a camera, etc., while the first occupant is interacting with a service provider using a phone, rolling down the window and speaking to a person, speaking to a person inside the vehicle, etc. As another example, the motion may include a user speaking, a user interacting with a user interface, etc. The sensors 401, 402, 403, 404, and 405 can feed the captured sensor data to a head unit 410. As another example, the sensor data may be fed to a vehicle computer, etc.

FIG. 4B illustrates a process 400B of sensors within the vehicle detecting activity performed by a second occupant within an interior of the vehicle included in FIG. 4A. In the example of FIG. 4A, a second occupant is also within the vehicle and places an order with the service provider after the first occupant has finished placing their order. Here, one or more of the sensors capture audio and/or motion from a location 450 within the interior of the vehicle of the second occupant placing an addition to the order of the first occupant, and the sensor data is sent to the head unit 410.

According to various embodiments, the head unit 410 may combine both the sensor data from the first occupant and the sensor data from the second occupant to determine which occupant ordered which items from the service provider. For example, the head unit may include an AI model, a machine learning model, a natural language processing model, a combination thereof, and the like, to comprehend the words that are spoken. As another example, the head unit 410 may compare timestamps of the audio and timestamps in the video to identify which occupant spoke at which time and determine the split of the ordered items.

For example, FIG. 4C illustrates a process 400C of the head unit 410 receiving sensor data 442 captured of the first occupant and sensor data 452 captured of the second occupant during the ordering process with the service provider. Here, the head unit 410 receives the sensor data 442 and the sensor data 452 and determines which occupant ordered which items from the service provider and splits the order data. The split order data is then sent to a service provider terminal 460 to initiate a checkout process for purchasing the items from the service provider.

For example, FIG. 4D illustrates a process 400D of the head unit 410 distributing payment screens to different display devices within the vehicle based on the sensor data captured of the first and second occupants during the ordering process. In this example, the service provider terminal 460 generates a separate bill for each of the first occupant and the second occupant based on the data provided from the head unit 410 in FIG. 4C. Referring to FIG. 4D, the service provider terminal 460 forwards the split bills to the head unit 410. In response, the head unit 410 determines where to display the split bills based on the locations of both the first occupant and the second occupant.

Based on the sensor data 442 in FIG. 4C, the head unit 410 determines that the nearest display device within the vehicle to the first occupant is the display device 422, shown in FIG. 4D, in the back of the driver seat. However, this is just an example. As another example, the closest display device may be a paired mobile device that is being held by the user, on the seat, in their pocket, etc. Furthermore, the head unit 410 determines that the nearest display device to the second occupant is the display device 432, shown in FIG. 4D, in the back of the passenger seat. As such, the head unit 410 displays a first partial bill 444 on a user interface 424 of the display device 422 which is specific to the order placed by the first occupant and also displays a second partial bill 454 on a user interface 434 of the display device 432. The displaying of the first partial bill 444 on the display device 422 and the displaying of the second partial bill 454 on the display device 432 may be performed simultaneously and/or in sequence.

FIG. 4E illustrates a process 400E of the first occupant submitting a payment via the user interface 424 which may display charge/payment cards from the first occupant's digital wallet on the display device 422 in the back of the driver seat, and FIG. 4F illustrates a process 400F of the second occupant submitting a payment via the user interface 434 which may display charge/payment cards from the second occupant's digital wallet on the display device 432. Here, each occupant may enter their own payment information into the respective display device 422 and the display device 432. The payment information may be forwarded to the head unit 410 which executes the payment transactions with the service provider terminal 460. For example, the head unit 410 may execute one of the payments at a time (in sequence) to enable the service provider terminal 460 to process each payment separately.

In one embodiment, the instant solution provides a method for a vehicle to handle parking payments directly from the vehicle's head unit. The instant solution utilizes an array of sensors in the vehicle, including microphones for voice recognition, seat occupancy sensors, and the GPS unit for location tracking. It is integrated with the vehicle's infotainment or head unit system, which serves as the user interface and communication hub. The instant solution connects to a cloud-based service that maintains real-time parking space availability and pricing data and a secure payment gateway for processing transactions. An occupant initiates the parking payment process using a voice command, such as “Pay for parking.” The vehicle's microphone array detects the command, and the instant solution uses voice recognition to determine which occupant gave the command by analyzing voice pitch, location within the vehicle, and whether the seat sensor detects occupancy. Utilizing the vehicle's GPS location, the instant solution contacts the cloud service to find nearby parking options and rates. It presents these options to the occupant through the vehicle's display system. The occupant selects the preferred parking option using voice commands or through a touchscreen interface. Once the selection is made, the instant solution confirms the choice and the parking duration and prompts the occupant to proceed with payment, displaying payment details and digital wallet card options through a connected mobile device. After the payment details are entered and authorized, the instant solution processes the transaction through the payment gateway. It provides a visual and auditory confirmation of the payment on the nearest screen to the occupant or through the vehicle's audio system. A digital receipt is displayed on the screen or sent to the occupant's mobile device. If the parking location differs from the vehicle's current location, it offers to navigate to the parking spot. Sensitive data input and transactions are encrypted. Additionally, voice recognition technology prevents unauthorized access to payment systems. Personalization options allow occupants to save payment preferences and frequently used parking locations, enabling faster transactions on subsequent uses. The instant solution synchronizes with occupants' mobile devices, allowing for remote control of the parking payment process and the ability to receive notifications about parking time limits or to extend parking time remotely. The instant solution also automatically suggests cost-effective parking options based on the vehicle's schedule, known routes, and past parking behavior. The instant solution integrates with charging station payments for electric vehicles, allowing users to pay for parking and charging in one transaction.

In one embodiment, the instant solution utilizes a vehicle's head unit to optimize fuel purchasing. The instant solution is connected to the vehicle's head unit, the central control for user interaction. It utilizes the vehicle's existing sensors, such as fuel level sensors, GPS for location services, and its onboard computer to access real-time traffic and fuel price data. The instant solution integrates with a network of fuel stations to facilitate communication and transactions directly from the vehicle and continuously monitors the vehicle's fuel level. When it reaches a pre-set threshold, the instant solution notifies the occupants through the head unit display or audible alerts, suggesting a refueling. The instant solution uses the vehicle's GPS data to locate nearby fuel stations and retrieves real-time fuel prices, perhaps through a connected service or partnership with fuel stations. It displays a list of stations with prices and additional services offered (e.g., car wash, convenience store). Considering real-time traffic data, the instant solution suggests the most time-efficient route to the selected fuel station, including the current journey, anticipated fuel consumption, and any potential delays along the way to the station. Occupants select the preferred fuel station and fuel type using voice commands or the head unit's touch interface. The instant solution pre-authorizes a set amount for fuel purchase or allows for post-fueling payment. Once the fuel type and amount are confirmed, the instant solution prompts for payment. Payments are processed using saved payment methods, digital wallets, mobile device integration, or in-car payment systems that comply with PCI-DSS (Payment Card Industry Data Security Standard) guidelines. After refueling, the instant solution provides a digital receipt and records the transaction for future reference or expense tracking. Users set preferences for fuel brands, payment methods, and how often they are alerted about low fuel levels. The instant solution integrates with fuel station loyalty programs, automatically applying discounts or rewards based on the user's membership details. For shared rides or carpool situations, the instant solution splits the fuel bill among occupants, displaying individual charges on their connected devices or on the nearest display within the vehicle. All transactions are securely processed with end-to-end encryption. User data, including payment information and fuel preferences, are stored securely and comply with privacy regulations. While primarily focused on fuel purchases, the instant solution can be adapted for electric vehicles by locating charging stations and managing payments for charging services. The instant solution accepts over-the-air updates to include new features or expand the participating fuel station network.

In one embodiment, the instant solution utilizes a vehicle's head unit to streamline the ordering and payment process at drive-thru restaurants. The instant solution is connected to the vehicle's head unit, which includes microphones for voice commands, a display for visual feedback, and an onboard computer system capable of wireless communication with external networks. It integrates with the vehicle's internal cameras and seat sensors to identify and engage with occupants. The instant solution requires integration with drive-thru restaurant order and payment systems for real-time communication and transaction processing. Occupants place drive-thru orders using voice commands. The advanced voice recognition differentiates between the occupants' voices, aligning each order with the respective person. After receiving the voice commands, the instant solution displays the orders to each occupant on the nearest screen for confirmation. It allows for customization of the order items (e.g., no pickles or extra cheese). This step ensures the accuracy and personalization of each order. Once the orders are confirmed, the instant solution wirelessly communicates with the drive-thru ordering system, sending each order directly to the restaurant's kitchen. The restaurant's system confirms receipt and gives an estimated wait time, relayed to the occupants via the head unit. The instant solution calculates the cost for each order and offers to split the bill if necessary. Occupants confirm and process their payments through the head unit, which securely transacts with the restaurant's payment system. Payment methods include pre-saved credit card information, mobile payment options, digital wallets, or in-car payment solutions. As the vehicle approaches the pickup window, the instant solution provides real-time updates on order status. If there's a delay, the instant solution communicates this to the occupants. Upon picking up the order, digital receipts are displayed on the head unit or sent to the occupants' connected mobile devices or the nearest display to the occupant within the vehicle. The instant solution also logs the transaction for convenience in future order history and quick reordering of favorite items. To cater to diverse occupants, the instant solution operates in multiple languages. The instant solution recognizes the occupants based on previous trips and suggests favorite or frequent orders, expediting the ordering process. For occupants connected via a social network or vehicle group settings, the instant solution suggests sharing meals or ordering together for discounts or combined offers.

In one embodiment, the instant solution facilitates ordering routine vehicle maintenance or services directly from the vehicle. The instant solution integrates a vehicle's head unit with a comprehensive vehicle maintenance platform that includes a network of service providers. It utilizes a vehicle's diagnostic systems to detect maintenance needs or allows manual input of maintenance requests by the user. Secure payment processing capabilities are integrated into the instant solution to handle transactions. The instant solution continuously monitors the vehicle's health through onboard diagnostics. When a need for maintenance is detected or a routine maintenance schedule approaches, the instant solution alerts the vehicle owner via the head unit. The owner uses voice commands or the touch interface to browse available maintenance services, to select a preferred service provider, and to schedule an appointment. The instant solution uses GPS data to suggest nearby authorized service providers with available appointments that fit the vehicle owner's schedule. Once the service is selected, the instant solution provides a detailed quote for the service, including parts and labor. The owner reviews the service details and confirms the appointment. For payment, the owner chooses from saved payment methods or adds a new one. The instant solution processes the payment securely and may offer to store the payment method for future use. On the appointment day, the owner drives the vehicle to the service center or opts for a pick-up service if available. The instant solution also provides an option for the service to be performed at the owner's location. During the service, the vehicle owner receives real-time updates on the maintenance progress through the head unit. A digital receipt is provided once the service is completed, and the service history is updated in the vehicle's system for future reference. Owners subscribe to a maintenance plan that automatically schedules services based on the vehicle's usage and manufacturer recommendations. The instant solution automatically checks the vehicle's warranty status and applies any eligible services or discounts. After the service, owners rate the service provider and leave feedback through the head unit, helping to improve service quality and customer satisfaction. All personal and payment information is encrypted and processed through secure channels to protect the owner's data. The instant solution includes additional services such as vehicle customization, detailing, and integration with insurance providers for seamless claim processing related to maintenance issues. Updates and new features are added through over-the-air software updates, keeping the vehicle's systems current with the latest technologies and services.

In one embodiment, the instant solution enables passengers to browse, book, and pay for entertainment and tourism-related activities through the vehicle's head unit. The interface is integrated with the vehicle's central infotainment system, including a display screen, voice recognition capabilities, and internet connectivity. It connects to a broad database of entertainment and tourism venues, including theaters, concert halls, museums, parks, and other attractions. The instant solution includes a secure payment gateway for processing transactions and a digital ticketing service. Passengers browse a curated list of local attractions, events, and activities, which the instant solution suggests based on the vehicle's location, the time of day, and the passengers' previously expressed preferences and booking history. Passengers discover details about each venue or event through voice commands or the touch interface, such as descriptions, reviews, available dates and times, and ticket prices. They view videos or images of the attractions if available on the vehicle's display. Once an event or attraction is selected, the instant solution guides the passengers through the booking process, allowing them to choose seats, times, and any additional experiences or perks associated with their visit. Passengers securely complete their transactions using stored payment methods or entering new payment details. The instant solution processes the payment and provides immediate confirmation and digital tickets displayed on personal devices or printed if the vehicle is equipped with a printer. Booked events are added to a digital calendar accessible through the head unit. The instant solution sets reminders for the event and offers to navigate to the venue. For tourism bookings that involve guided tours or experiences requiring equipment, the instant solution arranges for rentals or purchases to be ready upon arrival. The instant solution learns from user interactions and refines its suggestions over time to align with the passengers' tastes and preferences. Passengers connect with friends or family to coordinate joint outings, sharing event details and booking information. The interface provides support in multiple languages to accommodate non-native speakers. The interface ensures that all personal and financial data are encrypted, and privacy settings are in place to protect users' information. The instant solution includes virtual tours and experiences, allowing passengers to visit destinations virtually in transit. Integrating city passes and tourism cards gives users discounted access to multiple venues.

In one embodiment, the instant solution integrates a vehicle's head unit with an emergency services payment system. In an emergency, the vehicle occupants use the head unit to contact emergency services and pre-authorize payment for roadside assistance, ambulance, or urgent care. The instant solution identifies which occupant is initiating the emergency request by utilizing the vehicle's onboard sensors (such as microphones, cameras, and seat pressure sensors). The instant solution is capable of pre-authorizing payment for emergency services. The head unit pre-authorizes payment and communicates directly with the emergency service provider, whether it's roadside assistance, an ambulance service, or urgent care facilities. Once the person initiating the request is identified and the service is provided, the instant solution shares the relevant payment information with the service provider, eliminating the need for manual payment or the exchange of physical payment methods.

In one embodiment, the instant solution automates toll fee settlement from a vehicle. As the vehicle approaches a toll gate, the head unit communicates with the toll collection system through wireless communication technologies such as radio frequency identification (RFID), near field communication (NFC), or other electronic toll collection protocols. The instant solution uses the vehicle's onboard seat sensors to identify which occupant will be responsible for paying the toll either by designating the driver by default or allowing any of the occupants to assume payment responsibilities, depending on the vehicle's settings and the preferences of the occupants. In a scenario where the vehicle is a shared mode of transport, like a carpool or a ride-share, the instant solution automatically splits the toll fee among the occupants based on pre-set agreements or commands given to the head unit. After the toll has been paid, the instant solution generates electronic receipts displayed on the nearest screen available to each occupant who shared the cost. The screen is integrated into the vehicle, such as a smart dashboard display, or it can be an occupant's personal device like a smartphone. The instant solution integrates with financial accounts and digital wallets linked to the head unit, allowing for an immediate and secure transaction without the need for physical forms of payment.

In one embodiment, the instant solution facilitates hotel booking, check-in, and payment through a vehicle's head unit. Before reaching the hotel, occupants interact with the vehicle's head unit to book a room at their destination hotel. Upon arrival, the vehicle-integrated system communicates with the hotel's check-in system to complete the check-in process. Using secure communication protocols, the vehicle's head unit transmits the occupants' reservation and payment details to the hotel. The instant solution processes the payment for the hotel stay using pre-stored payment methods linked to the head unit or by prompting the occupants for payment details at the time of booking or check-in. The nearest screen to the occupant who made the reservation, a built-in screen in the vehicle or a personal mobile device, displays the payment confirmation and room details, allowing occupants to bypass the front desk and proceed directly to their room. The instant solution stores and communicates the occupants' room preferences to the hotel, ensuring that any specific requirements are met before arrival.

In one embodiment, the instant solution facilitates interaction between a vehicle's head unit and a service provider. The instant solution communicates with service providers through the vehicle's head unit, a central console that serves as the primary interface for such interactions. The head unit has advanced communication capabilities, allowing it to connect seamlessly with external service providers such as merchants, emergency services, toll collection systems, or other service providers. The instant solution captures sensor data from the vehicle's interior through an array of sensors, including microphones, cameras, and seat pressure sensors. The sensors are strategically placed throughout the vehicle to accurately capture the occupants' audio, visual, and physical cues. The instant solution utilizes sensor data to pinpoint the location of the occupants within the vehicle during an interaction with a service provider. For instance, if an occupant speaks an order or request, the instant solution can determine who among the occupants made the statement based on audio input and seat occupancy data. Once the occupant's location is determined, the instant solution displays data related to the interaction on the most appropriate user interface. The vehicle is equipped with multiple user interfaces, which include integrated display screens within the interior, such as screens in the headrests or central console, and potentially occupants' mobile devices. The instant solution identifies the closest available user interface to the occupant and displays the relevant information on the interface, such as payment options or order details. This feature ensures that each occupant receives personalized interaction and data display based on their position in the vehicle. Occupants enter their payment account data directly on the screen, which the instant solution transmits to the service provider via the head unit.

In one embodiment, the interaction from the vector may be a filtered interaction. A filtered interaction is an interaction that is obtained from many interactions where the vector is obtained between the interactions and location data. The interactions may be filtered by removing specific data from the interactions. For example, the interactions may be filtered by time of day, location, occupants in the vehicle, hardware and/or software of the device obtaining the interaction, and/or any other element.

In one embodiment, determine a location of a source of the interaction is determined within the vehicle based on a location data captured from the interior of the vehicle. In one embodiment, data related to the interaction is displayed between the service provider and the occupant on a user interface from among a plurality of available user interfaces within the vehicle based on the location of the occupant within the vehicle.

In one embodiment, the instant solution captures audio and video data of a vehicle's occupants during interactions with a service provider. The vehicle has various sophisticated hardware sensors, including audio and video-capturing devices. The devices are strategically positioned within the vehicle's interior to optimally capture the activities and interactions of the occupants. The audio sensors (microphones) pick up voice commands, conversations, and audible interactions between the occupants and the service providers. The video sensors (cameras) visually record the occupants, providing valuable contextual information about who is speaking, their gestures, and their location within the vehicle. The instant solution processes the data captured by the sensors in real-time. When an occupant interacts with a service provider through the vehicle's head unit, the instant solution captures both the audio and video data of the occupant, which is crucial for accurately identifying and understanding the occupant's requests and responses. Once the audio and video data are captured, the instant solution analyzes the information to determine the occupant involved in the interaction. The determination is based on voice recognition, visual identification, and the occupant's location within the vehicle. The ability to integrate audio and visual cues enables accurate and reliable identification in scenarios where multiple occupants might speak or interact simultaneously. After identifying the interacting occupant, the instant solution communicates the information to the head unit. The head unit, which acts as the primary interface for external communications, uses the data to tailor the interaction with the service provider. For example, suppose the occupant is ordering food at a drive-thru. In that case, the head unit can display the order details and payment options on the closest user interface to that occupant. This may be a screen integrated into the vehicle or the occupant's personal mobile device. The system includes voice-activated commands or gesture control facilitated by the combined audio and video data analysis. The features enhance the user experience by providing more intuitive and natural ways of interacting with the instant solution.

In one embodiment, the instant solution identifies the nearest available user interface to an occupant within a vehicle and displays interaction data on the interface. The instant solution includes a vehicle head unit, which serves as the central interface for communication with external service providers and is integrated with the vehicle's audio and visual display systems. The vehicle is equipped with various sensors, including but not limited to microphones, cameras, and seat pressure sensors. The sensors collect data about the occupants' positions, movements, and interactions. The instant solution analyzes the sensor data to pinpoint the exact location of the occupant within the vehicle who is engaging with a service provider. Once the occupant's location is identified, the instant solution determines the nearest available user interface to the occupant. The vehicle contains multiple user interfaces, including integrated screens in different parts of the vehicle, such as the dashboard, headrests, central console, and potentially even the occupants' personal mobile devices. The instant solution evaluates the distance and accessibility of each interface from the occupant's location and selects the closest and most convenient for the occupant to view and interact with. After selecting the nearest user interface, the instant solution displays data related to the occupant's interaction with the service provider on the interface. For example, suppose an occupant is ordering food through a drive-thru. In that case, the processor will display the order summary and payment options on the screen closest to that occupant, whether an integrated screen or a mobile device.

In one embodiment, the instant solution integrates a vehicle's head unit with a plurality of user interfaces within the vehicle. The head unit of the vehicle acts as the main communication hub. The head unit has advanced connectivity features, allowing it to interface with various external service providers, from merchant systems for ordering goods or services to emergency services or toll payment systems. The head unit is also the primary control center for the vehicle's internal communication system, linking to various user interfaces. The vehicle is equipped with multiple user interfaces, which include a variety of display screens integrated into the interior of the vehicle. The screens can be in different areas, such as the dashboard, the back of headrests for rear passengers, or even on the central console. Each screen is communicably coupled to the head unit, enabling each to receive and display information from the head unit. When an occupant interacts with a service provider through the vehicle's head unit, the instant solution captures the interaction and determines the most relevant user interface to display information related to this interaction. The determination of the appropriate screen depends on factors like the location of the occupant within the vehicle, the nature of the interaction, and the specific requirements of the information to be displayed. For example, if a driver is ordering food at a drive-thru, the processor might choose to display the order details and payment options on the dashboard screen. If a passenger in the back is simultaneously booking a hotel room, their booking details and payment options may be displayed on a screen integrated into the headrest in front of them. The instant solution allows the occupants to interact with different service providers at the same time, with the instant solution managing these parallel interactions efficiently, ensuring that the correct information is displayed on the right screen, minimizing confusion, and enhancing the user experience.

In one embodiment, the instant solution enables a vehicle's system to facilitate a payment transaction. The instant solution integrates a payment screen within the vehicle's user interfaces, including the vehicle's head unit or any other integrated display screen accessible to the occupants. When an occupant initiates a transaction with a service provider—for instance, placing an order at a drive-thru or paying for a toll—the instant solution triggers the display of a payment screen on the nearest or most convenient user interface for the occupant. The payment screen allows occupants to easily enter payment account data, including credit or debit card information, mobile payment options, digital wallet, or other digital payment methods. The instant solution ensures the security and confidentiality of this data through robust encryption and secure data handling protocols. Once the occupant enters the payment data, the instant solution completes the transaction. It processes the payment information, interfaces with the vehicle's head unit to communicate with the service provider's payment system, and securely transmits payment data. The instant solution also manages the authentication and authorization of the payment, ensuring that the transaction is completed successfully and securely. In addition to facilitating individual transactions, this instant solution can handle more complex payment scenarios. For example, suppose multiple occupants are placing separate orders or incurring costs. In that case, the system can split the payment, accordingly, displaying different payment screens for each occupant and processing each transaction individually.

In one embodiment, the instant solution captures multi-occupant sensor data, allowing more than one vehicle occupant to engage with a service provider. The vehicle is equipped with an array of sensors, including microphones, cameras, and seat pressure sensors, distributed strategically throughout the vehicle's interior. The sensors capture a wide range of data, including audio, visual, and physical cues from all the occupants in the vehicle, distinguishing between the interactions of different occupants. The instant solution processes the sensor data to determine the activities and interactions of each occupant within the vehicle. When the vehicle's occupants interact with a service provider, such as placing orders at a drive-thru or communicating with an emergency service, the sensors capture the relevant data associated with each occupant using sophisticated data analysis techniques, allowing it to differentiate between the interactions of multiple occupants. For instance, it can identify when the first occupant places an order and then recognize when a second occupant begins to place a different order. The differentiation is achieved by analyzing the collected sensor data, such as voice recognition to identify who is speaking, video data to see who is engaging, and seat sensors to locate each occupant within the vehicle. Once the instant solution has identified and segregated the interactions of the different occupants, it communicates the information to the head unit. The head unit, serving as the primary interface for external communications, manages the separate interactions with the service provider. For example, it can transmit the first occupant's order to the merchant and then separately process the second occupant's order. Additionally, the display interfaces display each occupant's interaction data, and related information, such as order details or payment options, on the user interface closest to them, including vehicle interfaces as well as personal devices of the occupants.

In one embodiment, the instant solution determines the distinct locations of multiple occupants within a vehicle based on multi-occupant sensor data. The instant solution enables personalized interactions with each occupant by accurately identifying their positions within the vehicle. The vehicle is equipped with a comprehensive network of sensors, including but not limited to microphones, cameras, and seat pressure sensors. The sensors are intricately placed throughout the vehicle's interior to capture a wide array of data, which is critical in pinpointing the exact location of each occupant. The system analyzes the sensor data to distinguish occupants' locations while interacting with a service provider. For example, when two occupants simultaneously interact with a service provider—say, placing separate orders at a drive-thru—the processor uses the data from the microphones and cameras to identify which occupant is speaking and the seat sensors to determine where each occupant is seated. Once the system has accurately determined the location of each occupant, it communicates the information to the vehicle's head unit. The head unit, which serves as the central interface for interactions with external service providers, uses the information to appropriately manage and display the interaction data. For instance, the processor can direct the head unit to display the first occupant's order details on a screen closest to their seat and the second occupant's details on a different screen nearer to them. Order details, payment options, or emergency service requests are displayed on the most convenient and accessible user interface for that occupant, including integrated screens within the vehicle and personal mobile devices, depending on the occupant's location and preference. The system handles multiple occupant scenarios, such as splitting payments for a collective order or directing emergency services to the specific occupant who needs assistance. Processing and targeted display mechanisms make this system exceptionally adept at providing tailored services to each occupant in a multi-occupant scenario.

FIG. 4G illustrates an AI/ML network diagram 400G that supports AI-assisted vehicle or occupant decision points. Other branches of AI, such as, but not limited to, computer vision, fuzzy logic, expert systems, neural networks/deep learning, generative AI, and natural language processing, may all be employed in developing the AI model shown in these embodiments. Further, the AI model included in these embodiments is not limited to particular AI algorithms. Any algorithm or combination of algorithms related to supervised, unsupervised, and reinforcement learning algorithms may be employed.

In one embodiment, Generative AI (GenAI) may be used by the instant solution in the transformation of data. Vehicles are equipped with diverse sensors, cameras, radars, and LIDARs, which collect a vast array of data, such as images, speed readings, GPS data, and acceleration metrics. However, raw data, once acquired, undergoes preprocessing that may involve normalization, anonymization, missing value imputation, or noise reduction to allow the data to be further used effectively.

The GenAI executes data augmentation following the preprocessing of the data. Due to the limitation of datasets in capturing the vast complexity of real-world vehicle scenarios, augmentation tools are employed to expand the dataset. This might involve image-specific transformations like rotations, translations, or brightness adjustments. For non-image data, techniques like jittering can be used to introduce synthetic noise, simulating a broader set of conditions.

In the instant solution, data generation is then performed on the data. Tools like Generative Adversarial Networks (GANs) and Variational Autoencoders (VAEs) are trained on existing datasets to generate new, plausible data samples. For example, GANs might be tasked with crafting images showcasing vehicles in uncharted conditions or from unique perspectives. As another example, the synthesis of sensor data may be performed to model and create synthetic readings for such scenarios, enabling thorough system testing without actual physical encounters. A critical step in the use of GenAI, given the safety-critical nature of vehicles, is validation. This validation might include the output data being compared with real-world datasets or using specialized tools like a GAN's discriminator to gauge the realism of the crafted samples.

Vehicle node 410G may include a plurality of sensors 412G that may include but are not limited to, light sensors, weight sensors, cameras, lidar, and radar. In some embodiments, these sensors 412G send data to a database 420G that stores data about the vehicle and occupants of the vehicle. In some embodiments, these sensors 412G send data to one or more decision subsystems 416G in vehicle node 410G to assist in decision-making.

Vehicle node 410G may include one or more user interfaces (UIs) 414G, such as a steering wheel, navigation controls, audio/video controls, temperature controls, etc. In some embodiments, these UIs 414G send data to a database 420G that stores event data about the UIs 414G that includes but is not limited to selection, state, and display data. In some embodiments, these UIs 414G send data to one or more decision subsystems 416G in vehicle node 410G to assist decision-making.

Vehicle node 410G may include one or more decision subsystems 416G that drive a decision-making process around, but are not limited to, vehicle control, temperature control, charging control, etc. In some embodiments, the decision subsystems 416G gather data from one or more sensors 412G to aid in the decision-making process. In some embodiments, a decision subsystem 416G may gather data from one or more UIs 414G to aid in the decision-making process. In some embodiments, a decision subsystem 416G may provide feedback to a UI 414G.

An AI/ML production system 400G may be used by a decision subsystem 416G in a vehicle node 410G to assist in its decision-making process. The AI production system 430G includes one or more AI/ML models 432G that are executed to retrieve the needed data, such as, but not limited to, a prediction, a categorization, a UI prompt, etc. In some embodiments, an AI production system 430G is hosted on a server. In some embodiments, the AI production system 430G is cloud-hosted. In some embodiments, the AI production system 430G is deployed in a distributed multi-node architecture. In some embodiments, the AI production system resides in vehicle node 410G.

An AI/ML development system 440G creates one or more AI/ML models 432G. In some embodiments, the AI/ML development system 440G utilizes data in the database 420G to develop and train one or more AI models 432G. In some embodiments, the AI/ML development system 440G utilizes feedback data from one or more AI/ML production systems 430G for new model development and/or existing model re-training. In an embodiment, the AI/ML development system 440G resides and executes on a server. In another embodiment the AI/ML development system 440G is cloud hosted. In a further embodiment, the AI/ML development system 440G utilizes a distributed data pipeline/analytics engine.

Once an AI/ML model 432G has been trained and validated in the AI/ML development system 440G, it may be stored in an AI/ML repository 460G for retrieval by either the AI/ML development system 440G or by one or more AI/ML production systems 430G. The AI/ML repository 460G resides in a dedicated server in one embodiment. In some embodiments, the AI/ML repository 460G is cloud-hosted. The AI/ML repository 460G is a distributed database in other embodiments. In further embodiments, the AI/ML repository 460G resides in the AI/ML production system 430G.

FIG. 4H illustrates a process 400H for developing one or more AI/ML models that support AI-assisted vehicle or occupant decision points. An AI/ML development system 440G executes steps to develop an AI/ML model 432G that begins with data extraction 442H, in which data is loaded and ingested from one or more data sources. In some embodiments, vehicle and user data is extracted from a database 420G. In some embodiments, model feedback data is extracted from one or more AI/ML production systems 430G.

Once the required data has been extracted 442H, it must be prepared 444H for model training. In some embodiments, this step involves statistical testing of the data to see how well it reflects real-world events, its distribution, the variety of data in the dataset, etc. In some embodiments, the results of this statistical testing may lead to one or more data transformations being employed to normalize one or more values in the dataset. In some embodiments, this step includes cleaning data deemed to be noisy. A noisy dataset includes values that do not contribute to the training, such as but are not limited to, null and long string values. Data preparation 444H may be a manual process or an automated process using one or more of the elements, functions described or depicted herein.

Features of the data are identified and extracted 446H. In some embodiments, a feature of the data is internal to the prepared data from step 444H. In other embodiments, a feature of the data requires a piece of prepared data from step 444H to be enriched by data from another data source to be useful in developing an AI/ML model 432G. In some embodiments, identifying features is a manual process or an automated process using one or more of the elements, functions described or depicted herein. Once the features have been identified, the values of the features are collected into a dataset that will be used to develop the AI/ML model 432G.

The dataset output from feature extraction step 446H is split 448H into a training and validation data set. The training data set is used to train the AI/ML model 432G, and the validation data set is used to evaluate the performance of the AI/ML model 432G on unseen data.

The AI/ML model 432G is trained and tuned 450H using the training data set from step 448H. In this step, the training data set is fed into an AI/ML algorithm and an initial set of algorithm parameters. The performance of the AI/ML model 432G is then tested within the AI/ML development system 440G utilizing the validation data set from step 448H. These steps may be repeated with adjustments to one or more algorithm parameters until the model's performance is acceptable based on various goals and/or results.

The AI/ML model 432G is evaluated 452H in a staging environment (not shown) that resembles the ultimate AI/ML production system 430G. This evaluation uses a validation dataset to ensure the performance in an AI/ML production system 430G matches or exceeds expectations. In some embodiments, the validation dataset from step 448H is used. In other embodiments, one or more unseen validation datasets are used. In some embodiments, the staging environment is part of the AI/ML development system 440G. In other embodiments, the staging environment is managed separately from the AI/ML development system 440G. Once the AI/ML model 432G has been validated, it is stored in an AI/ML model registry 460G, which can be retrieved for deployment and future updates. As before, in some embodiments, the model evaluation step 452H is a manual process or an automated process using one or more of the elements, functions described or depicted herein.

Once an AI/ML model 432G has been validated and published to an AI/ML model registry 460G, it may be deployed 454H to one or more AI/ML production systems 430G. In some embodiments, the performance of deployed AI/ML models 432G is monitored 456H by the AI/ML development system 440G. In some embodiments, AI/ML model 432G feedback data is provided by the AI/ML production system 430G to enable model performance monitoring 456H. In some embodiments, the AI/ML development system 440G periodically requests feedback data for model performance monitoring 456H. In some embodiments, performance monitoring includes one or more triggers that result in the AI/ML model 432G being updated by repeating steps 442H-454H with updated data from one or more data sources.

FIG. 4I illustrates a process 400I for utilizing an AI/ML model that supports AI-assisted vehicle or occupant decision points. As stated previously, the AI model utilization process depicted herein reflects ML, which is a particular branch of AI, but this invention is not limited to ML and is not limited to any AI algorithm or combination of algorithms.

Referring to FIG. 4I, an AI/ML production system 430G, may be used by a decision subsystem 416G in vehicle node 410G to assist in its decision-making process. The AI/ML production system 430G provides an application programming interface (API) 334, executed by an AI/ML server process 436I through which requests can be made. In some embodiments, a request may include an AI/ML model 432G identifier to be executed. In some embodiments, the AI/ML model 432G to be executed is implicit based on the type of request. In some embodiments, a data payload (e.g., to be input to the model during execution) is included in the request. In some embodiments, the data payload includes sensor 412G data from vehicle node 410G. In some embodiments, the data payload includes UI 414G data from vehicle node 410G. In some embodiments, the data payload includes data from other vehicle node 410G subsystems (not shown), including but not limited to, occupant data subsystems. In an embodiment, one or more elements or nodes 420G, 430G, 440G, or 460G may be located in the vehicle 410G.

Upon receiving the API 434I request, the AI/ML server process 436I may need to transform the data payload or portions of the data payload to be valid feature values into an AI/ML model 432G. Data transformation may include but is not limited to combining data values, normalizing data values, and enriching the incoming data with data from other data sources. Once any required data transformation occurs, the AI/ML server process 436I executes the appropriate AI/ML model 432G using the transformed input data. Upon receiving the execution result, the AI/ML server process 436I responds to the API caller, which is a decision subsystem 416G of vehicle node 410G. In some embodiments, the response may result in an update to a UI 414G in vehicle node 410G. In some embodiments, the response includes a request identifier that can be used later by the decision subsystem 416G to provide feedback on the AI/ML model 432G performance. Further, in some embodiments, immediate performance feedback may be recorded into a model feedback log 438I by the AI/ML server process 436I. In some embodiments, execution model failure is a reason for immediate feedback.

In some embodiments, the API 434I includes an interface to provide AI/ML model 432G feedback after an AI/ML model 432G execution response has been processed. This mechanism may be used to evaluate the performance of the AI/ML model 432G by enabling the API caller to provide feedback on the accuracy of the model results. For example, if the AI/ML model 432G provided an estimated time of arrival of 20 minutes, but the actual travel time was 24 minutes, that could be indicated. In some embodiments, the feedback interface includes the identifier of the initial request so that it can be used to associate the feedback with the request. Upon receiving a call into the feedback interface of API 434I, the AI/ML server process 436I records the feedback in the model feedback log 438I. In some embodiments, the data in this model feedback log 438I is provided to model performance monitoring 456H in the AI/ML development system 440G. This log data is streamed to the AI/ML development system 440G in one embodiment. In some embodiments, the log data is provided upon request.

A number of the decisions/steps that may utilize the AI/ML process described herein include: establishing a channel between a mobile device and a head unit within a vehicle, retrieving, by the head unit, one or more charge cards from a digital wallet installed on the mobile device via the channel, displaying identifiers of the one or more charge cards on a user interface of the head unit in association with an activity, receiving an input from the user interface of the head unit which selects a charge card from among the one or more charge cards, and transmitting an authorization request from the head unit to an issuing system of the charge card, over a computer network, with a request to authorize the activity. The decision/steps may also include: receiving authorization from the issuing system via the computer network, and in response, executing a disbursement process for the activity with the charge card via the head unit, pre-authorizing the disbursement process in response to receiving the input from the user interface of the head unit, pairing the mobile device with the head unit through a Bluetooth channel, displaying a multi-factor authentication request (MFA) window on the mobile device with a request to authorize the charge card, receiving validation data from the MFA window on the mobile device, and transmitting the authorization request from the head unit to the issuing system in response to receiving the validation data from the MFA window on the mobile device, receiving the validation data comprises receiving a biometric input from a user via the MFA window on the mobile device, comparing the biometric input to a previously stored reference biometric input, and determining the charge card is authorized based on the biometric input, identifying a destination of the vehicle as the vehicle is travelling along a route, and identifying an item of interest based on the destination, wherein the displaying the identifiers of the one or more charge cards further comprises displaying an identifier of the item, and transmitting a disbursement request authorization message with a card present indicator.

The decisions/steps may also include: communicating with a service provider via a head unit of a vehicle, Capturing sensor data from an interior of the vehicle during an interaction between the service provider and an occupant within the vehicle, Determining a location of the occupant within the vehicle based on the sensor data captured from the interior of the vehicle, Displaying data related to the interaction between the service provider and the occupant on a user interface from among a plurality of available user interfaces within the vehicle based on the location of the occupant within the vehicle. The decision/steps may also include capturing one or more of audio and video of the occupant from one or more hardware sensors installed within the vehicle while the interaction is occurring, identifying a closest available user interface to the occupant from among the plurality of available user interfaces based on the location of the occupant within the vehicle, and the displaying comprises displaying the data related to the interaction on the closest available user interface, the plurality of available user interfaces communicably coupled to the head unit of the vehicle, and the plurality of available user interfaces include a plurality of display screens integrated within the interior of the vehicle, displaying a digital wallet screen on the user interface within the vehicle, receiving digital wallet data via the digital wallet screen on the user interface, and transmitting the digital wallet data to the service provider from the head unit of the vehicle, capturing multi-occupant sensor data that includes a first occupant within the vehicle interacting with the service provider and a second occupant within the vehicle interacting with the service provider, determining the location of the first occupant within the vehicle based on the multi-occupant sensor data and determining a different location of the second occupant within the vehicle based on the multi-occupant sensor data, and displaying data related to the interaction between the service provider and the first occupant on a first user interface from among the plurality of available user interfaces within the vehicle based on the location of the first occupant within the vehicle, and displaying, data related to the interaction between the service provider and the second occupant on a second user interface from among the plurality of available user interfaces within the vehicle based on the different location of the second occupant within the vehicle.

Data associated with any of these steps/features, as well as any other features or functionality described or depicted herein, the AI/ML production system 430G, as well as one or more of the other elements depicted in FIG. 4I may be used to process this data in a pre-transformation and/or post-transformation process. Data related to this process can be used by the vehicle node 410G. In one embodiment, data related to this process may be used with any of the processors described or depicted herein.

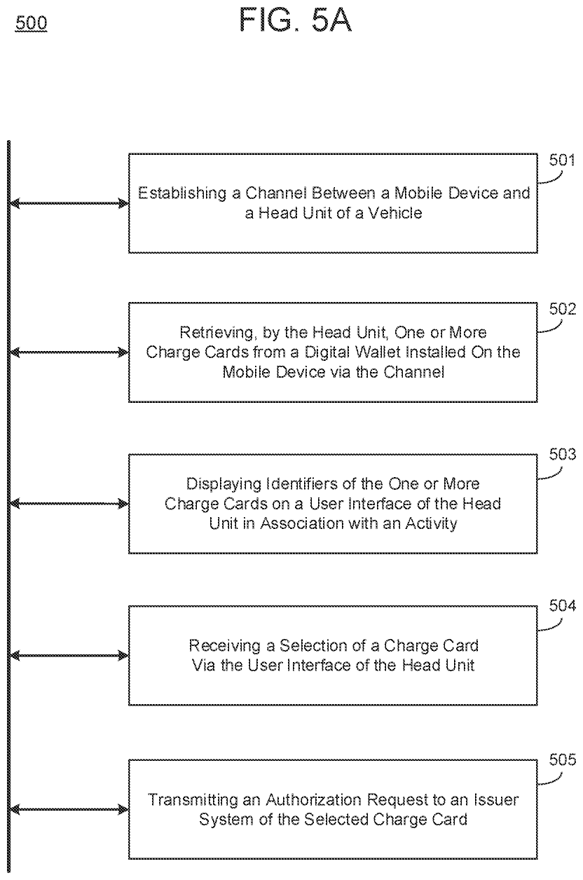

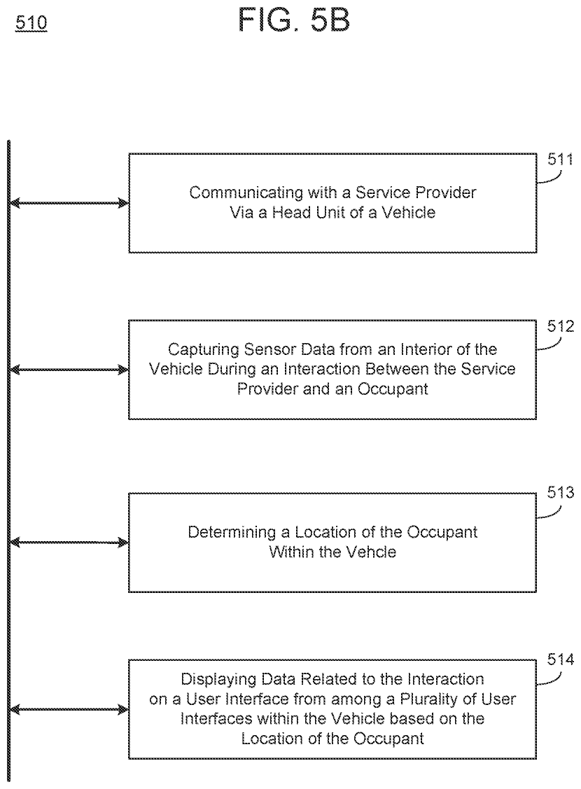

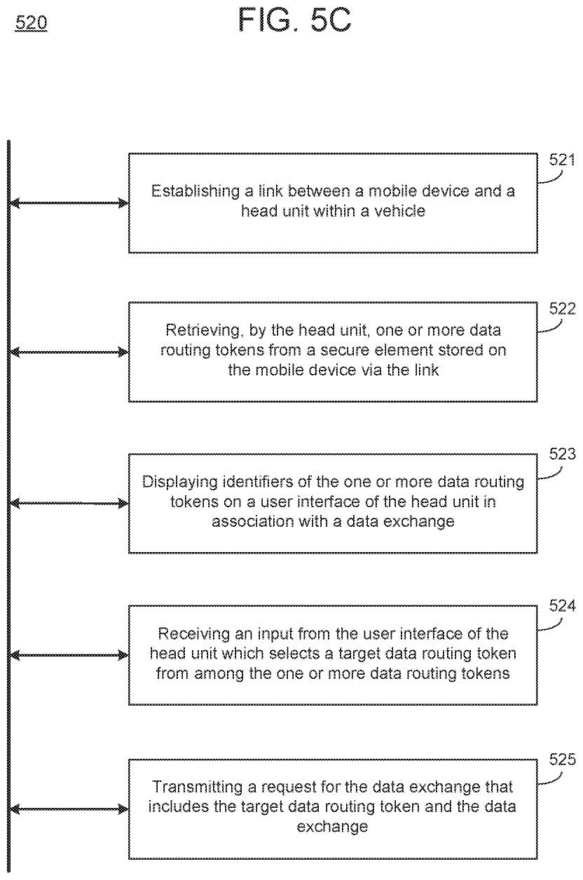

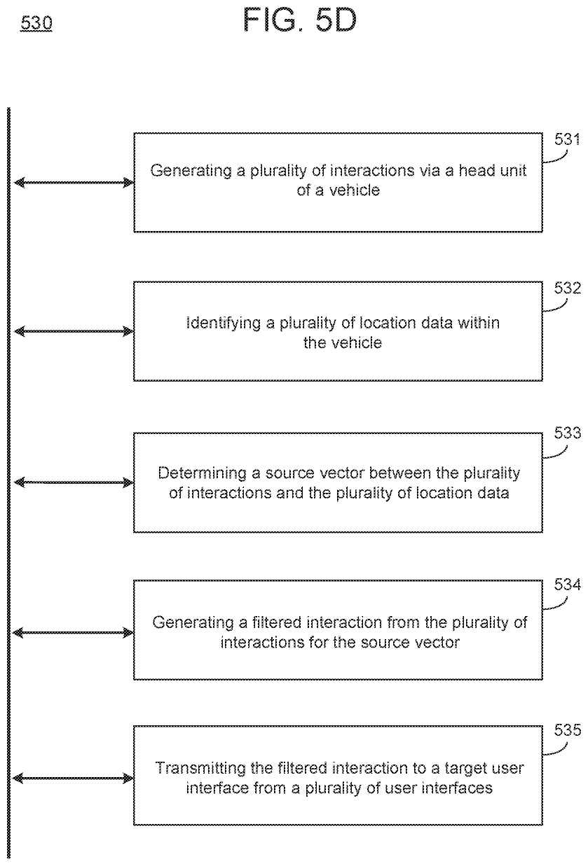

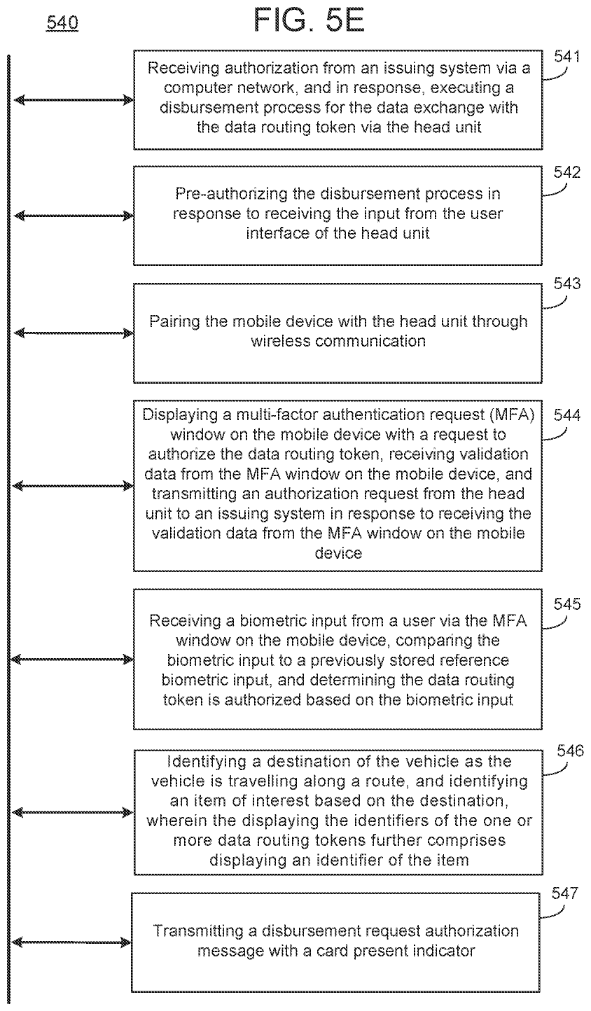

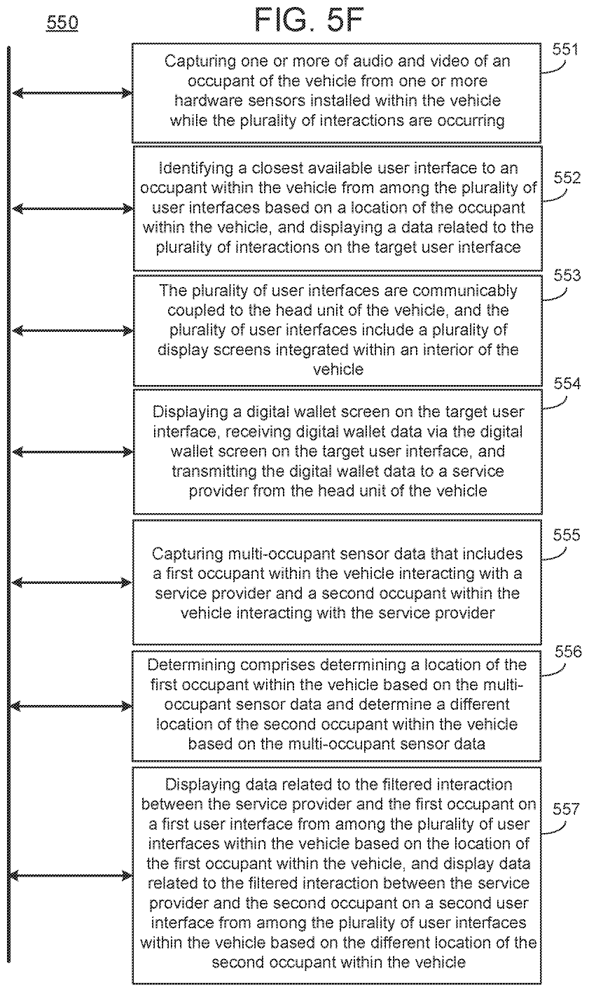

FIG. 5A illustrates a method 500 of transmitting a payment request from an automotive head unit according to example embodiments. For example, the method 500 may be performed by a host platform such as a web server, cloud platform, on-premises server, or the like. Referring to FIG. 5A, in 501, the method may include establishing a channel/connection between a mobile device and a head unit within a vehicle. The connection may be a Bluetooth channel, however, embodiments are not limited thereto. As another example, the mobile device may be paired with the head unit using a cable, or the like.

In 502, the method may include retrieving, by the head unit, one or more charge/payment cards from a digital wallet installed on the mobile device via the established channel/connection. In 503, the method may include displaying identifiers of the one or more charge/payment cards on a user interface of the head unit in association with an activity. In 504, the method may include receiving an input from the user interface of the head unit which selects a charge/payment card from among the one or more charge/payment cards. In 505, the method may include transmitting an authorization request from the head unit to an issuing system of the selected charge/payment card, over a computer network, with a request to authorize the activity.

In some embodiments, the method may further include receiving authorization from the issuing system via the computer network, and in response, executing a disbursement process to pay for the activity with the selected charge/payment card via the head unit. In some embodiments, the method may further include pre-authorizing the disbursement process in response to receiving the input from the user interface of the head unit, wherein the pre-authorizing comprises transmitting an authorization request to the issuing system prior to receiving a request for executing the payment via the head unit. In some embodiments, the establishing the connection may include pairing the mobile device with the head unit through a Bluetooth channel.

In some embodiments, the method may further include displaying a multi-factor authentication request (MFA) window on the mobile device with a request to authorize the selected charge/payment card, receiving authorization for using the selected charge/payment card based on an input via the MFA window on the mobile device, and transmitting the authorization request from the head unit to the issuing system in response to receiving the authorization from the window on the mobile device. In some embodiments, the receiving the authorization may include receiving a biometric input from a user via the MFA window on the mobile device, comparing the biometric input to a previously stored reference biometric input, and determining the selected charge/payment card is authorized based on the comparison.

In some embodiments, the method may further include identifying a destination of the vehicle as the vehicle is travelling along a route, and identifying an item that the user is interested in based on the destination, wherein the displaying the identifiers of the one or more charge/payment cards further comprises displaying an identifier of the item. In some embodiments, the transmitting of the authorization request from the head unit to the issuing system of the selected charge/payment card may include transmitting a disbursement request authorization message with a card present indicator.

FIG. 5B illustrates a method 510 of displaying transaction data in a vehicle based on a location of an occupant involved in the transaction according to example embodiments. For example, the method 510 may be performed by a host platform such as a web server, cloud platform, on-premises server, or the like. Referring to FIG. 5B, in 511, the method may include communicating with a service provider via a head unit of a vehicle. The communication may include a network communication such as a message transmission sent to an electronic payment terminal, server, or other computing device of the service provider.

In 512, the method may include capturing sensor data from an interior of the vehicle during an interaction between the service provider and an occupant within the vehicle. In 513, the method may include determining a location of the occupant within the vehicle based on the sensor data captured from the interior of the vehicle. In 514, the method may include displaying data related to the interaction between the service provider and the occupant on a user interface from among a plurality of available user interfaces within the vehicle based on the location of the occupant within the vehicle.

In some embodiments, the capturing may include capturing one or more of audio and video of the occupant from one or more hardware sensors installed within the vehicle while the interaction is occurring. In some embodiments, the method may further include identifying a closest available user interface to the occupant from among the plurality of user interfaces based on the location of the occupant within the vehicle, and the displaying may include displaying the data related to the interaction on the closest available user interface. In some embodiments, the plurality of available user interfaces may be communicably coupled to the head unit of the vehicle, and the plurality of available user interfaces may include a plurality of display screens integrated within the interior of the vehicle.

In some embodiments, the displaying may include displaying a digital wallet screen on the user interface within the vehicle, receiving digital wallet data via the digital wallet screen on the user interface, and transmitting the digital wallet data to the service provider from the head unit of the vehicle. In some embodiments, the capturing may include capturing multi-occupant sensor data that includes a first occupant within the vehicle interacting with the service provider and a second occupant within the vehicle interacting with the service provider.

In some embodiments, the determining may include determining a location of the first occupant within the vehicle based on the multi-occupant sensor data and determining a location of the second occupant within the vehicle based on the multi-occupant sensor data. In some embodiments, the displaying the data may include displaying data related to the interaction between the service provider and the first occupant on a first user interface from among a plurality of available user interfaces within the vehicle based on the location of the first occupant within the vehicle, and displaying data related to the interaction between the service provider and the second occupant on a second user interface from among a plurality of available user interfaces within the vehicle based on the location of the second occupant within the vehicle.

FIG. 5C illustrates a method 520 of transmitting a payment request from an automotive head unit according to example embodiments. For example, the method 520 may be performed by a computing system, a software application, a server, a cloud platform, a combination of systems, and the like. Referring to FIG. 5C, in 521, the method may include establishing a link between a mobile device and a head unit within a vehicle. In 522, the method may include retrieving, by the head unit, one or more data routing tokens from a secure element stored on the mobile device via the link. In 523, the method may include displaying identifiers of the one or more data routing tokens on a user interface of the head unit in association with a data exchange. In 524, the method may include receiving an input from the user interface of the head unit which selects a target data routing token from among the one or more data routing tokens. In 525, the method may include transmitting a request for the data exchange that includes the target data routing token and the data exchange.

FIG. 5D illustrates a method 530 of displaying data related to the interaction between the service provider and the occupant based on the location of the occupant within the vehicle according to example embodiments. For example, the method 530 may be performed by a computing system, a software application, a server, a cloud platform, a combination of systems, and the like. Referring to FIG. 5D, in 531, the method may include generating a plurality of interactions via a head unit of a vehicle. In 532, the method may include identifying a plurality of location data within the vehicle. In 533, the method may include determining a source vector between the plurality of interactions and the plurality of location data. In 534, the method may include generating a filtered interaction from the plurality of interactions for the source vector. In 535, the method may include transmitting the filtered interaction to a target user interface from a plurality of user interfaces.

FIG. 5E illustrates a flow diagram for method 540, according to example embodiments. As an example, the method 540 may be performed by a computing system, a software application, a server, a cloud platform, a combination of systems, and the like. Referring to FIG. 5E, in 541, the method may include receiving authorization from an issuing system via a computer network, and in response, executing a disbursement process for the data exchange with the data routing token via the head unit. In 542, the method may include pre-authorizing the disbursement process in response to receiving the input from the user interface of the head unit. In 543, the method may include pairing the mobile device with the head unit through wireless communication. In 544, the method may include displaying a multi-factor authentication request (MFA) window on the mobile device with a request to authorize the data routing token, receiving validation data from the MFA window on the mobile device, and transmitting an authorization request from the head unit to an issuing system in response to receiving the validation data from the MFA window on the mobile device. In 545, the method may include receiving a biometric input from a user via the MFA window on the mobile device, comparing the biometric input to a previously stored reference biometric input, and determining the data routing token is authorized based on the biometric input. In 546, the method may include identifying a destination of the vehicle as the vehicle is travelling along a route, and identifying an item of interest based on the destination, wherein the displaying the identifiers of the one or more data routing tokens further comprises displaying an identifier of the item. In 547, the method may include transmitting a disbursement request authorization message with a card present indicator.

FIG. 5F illustrates a flow diagram for method 550, according to example embodiments. As an example, the method 550 may be performed by a computing system, a software application, a server, a cloud platform, a combination of systems, and the like. Referring to FIG. 5F, in 551, the method may include capturing one or more of audio and video of an occupant of the vehicle from one or more hardware sensors installed within the vehicle while the plurality of interactions are occurring. In 552, the method may include identifying a closest available user interface to an occupant within the vehicle from among the plurality of user interfaces based on a location of the occupant within the vehicle, and displaying a data related to the plurality of interactions on the target user interface. In 553, the method may include the plurality of user interfaces are communicably coupled to the head unit of the vehicle, and the plurality of user interfaces include a plurality of display screens integrated within an interior of the vehicle. In 554 the method may include displaying a digital wallet screen on the target user interface, receiving digital wallet data via the digital wallet screen on the target user interface, and transmitting the digital wallet data to a service provider from the head unit of the vehicle. In 555, the method may include capturing multi-occupant sensor data that includes a first occupant within the vehicle interacting with a service provider and a second occupant within the vehicle interacting with the service provider. In 556, the method may include determining comprises determining a location of the first occupant within the vehicle based on the multi-occupant sensor data and determine a different location of the second occupant within the vehicle based on the multi-occupant sensor data. In 557, the method may include displaying data related to the filtered interaction between the service provider and the first occupant on a first user interface from among the plurality of user interfaces within the vehicle based on the location of the first occupant within the vehicle, and display data related to the filtered interaction between the service provider and the second occupant on a second user interface from among the plurality of user interfaces within the vehicle based on the different location of the second occupant within the vehicle.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), digital versatile disc read-only memory (“DVD-ROM”) or any other form of storage medium known in the art.

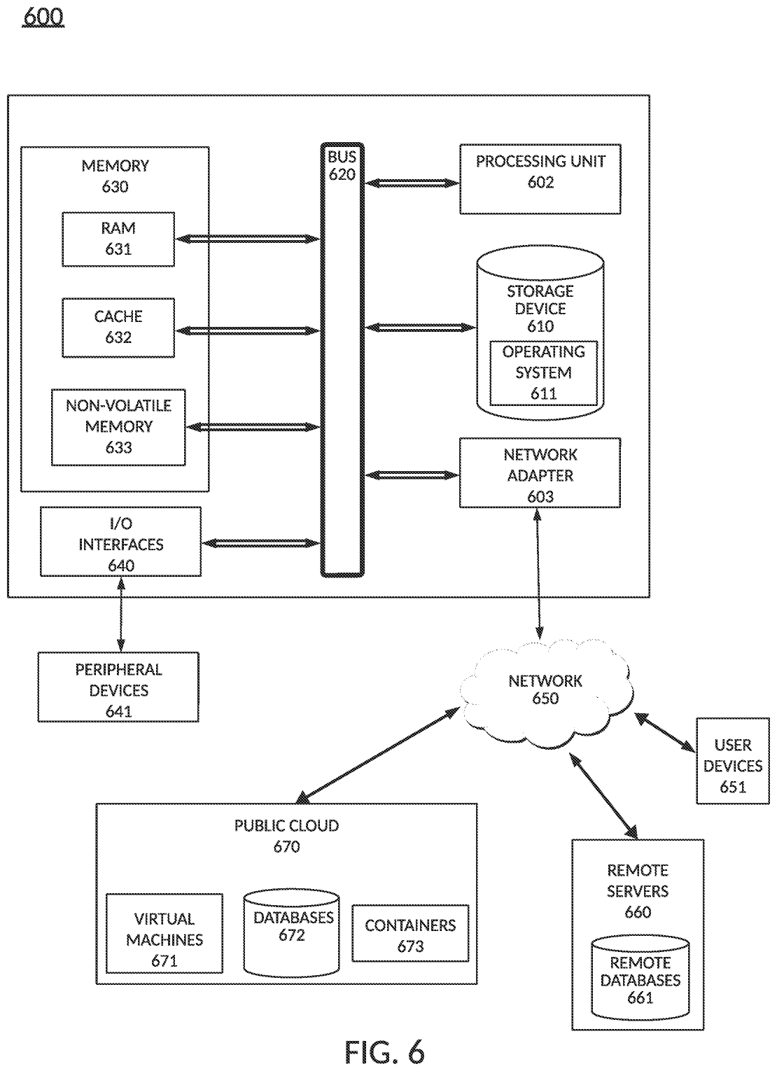

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example computer system architecture, which may represent or be integrated in any of the above-described components, etc.

Referring to FIG. 6, in computing node 600, a computer system/server 602 is operational with numerous other computing system environments or configurations. Examples of well-known computing systems, environments, and/or configurations that may be suitable for use with computer system/server 602 include but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 602 in cloud computing node 600 includes the components of computer system/server 602. These components may include but are not limited to, one or more processors or processing units 604, a system memory 606, and a bus that couples various system components, including system memory 606 to processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 includes a variety of computer system readable media. Such media may be any available media that is accessible by computer system/server 602, and it includes both volatile and non-volatile media, removable and non-removable media. System memory 606, in one example, implements the flow diagrams of the other figures. The system memory 606 can include computer system readable media in the form of volatile memory, such as random-access memory (RAM) 608 and/or cache memory 610. Computer system/server 602 may further include other removable/non-removable, volatile/non-volatile computer system storage media. By way of example only, memory 606 can be provided for reading from and writing to a non-removable, non-volatile magnetic media (not shown and may be called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility, having a set (at least one) of program modules, may be stored in memory 606 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of various embodiments of the application as described herein.

As will be appreciated, aspects of the present application may be embodied as a system, method, computer program product (such as a computer readable storage medium), an element or an apparatus. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable media(s) having computer readable program code embodied thereon.

Computer system/server 602 may also communicate with one or more external devices via an I/O device 612 (such as an I/O adapter), which may include a keyboard, a pointing device, a display, a voice recognition module, etc., one or more devices that enable a user to interact with computer system/server 602, and/or any devices (e.g., network card, modem, etc.) that enable computer system/server 602 to communicate with one or more other computing devices. Such communication can occur via I/O interfaces of the device 612. Still yet, computer system/server 602 can communicate with one or more networks such as a local area network (LAN), a general wide area network (WAN), and/or a public network (e.g., the Internet) via a network adapter. As depicted, device 612 communicates with the other components of computer system/server 602 via a bus. It should be understood that although not shown, other hardware and/or software components could be used in conjunction with computer system/server 602. Examples, include, but are not limited to: microcode, device drivers, redundant processing units, external disk drive arrays, RAID systems, tape drives, and data archival storage systems, etc. It should be further understood that one or more of the elements described or depicted in FIG. 6 can perform one or more of the actions, functionalities, or features described or depicted herein.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” may be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

1. An apparatus comprising:
a memory; and
a processor communicably coupled to the memory, the processor configured to:
generate a plurality of interactions via a head unit of a vehicle;
identify a plurality of location data within the vehicle;
determine a source vector between the plurality of interactions and the plurality of location data;
generate a filtered interaction from the plurality of interactions for the source vector; and
transmit the filtered interaction to a target user interface from a plurality of user interfaces.

2. The apparatus of claim 1, wherein the processor is further configured to capture one or more of audio and video of an occupant of the vehicle from one or more hardware sensors installed within the vehicle while the plurality of interactions are occurring.

3. The apparatus of claim 1, wherein the processor is further configured to identify a closest available user interface to an occupant within the vehicle from among the plurality of user interfaces based on a location of the occupant within the vehicle, and display a data related to the plurality of interactions on the target user interface.

4. The apparatus of claim 1, wherein the plurality of user interfaces are communicably coupled to the head unit of the vehicle, and the plurality of user interfaces include a plurality of display screens integrated within an interior of the vehicle.

5. The apparatus of claim 1, wherein the processor is further configured to display a digital wallet screen on the target user interface, receive digital wallet data via the digital wallet screen on the target user interface, and transmit the digital wallet data to a service provider from the head unit of the vehicle.

6. The apparatus of claim 1, wherein the processor is further configured to capture multi-occupant sensor data that includes a first occupant within the vehicle interacting with a service provider and a second occupant within the vehicle interacting with the service provider.

7. The apparatus of claim 6, wherein the processor is further configured to determine a location of the first occupant within the vehicle based on the multi-occupant sensor data and determine a different location of the second occupant within the vehicle based on the multi-occupant sensor data.

8. The apparatus of claim 7, wherein the processor is further configured to display data related to the filtered interaction between the service provider and the first occupant on a first user interface from among the plurality of user interfaces within the vehicle based on the location of the first occupant within the vehicle, and display data related to the filtered interaction between the service provider and the second occupant on a second user interface from among the plurality of user interfaces within the vehicle based on the different location of the second occupant within the vehicle.

9. The apparatus of claim 1, wherein the processor is configured to identify a proximal target user interface to the source vector.

10. The apparatus of claim 1, wherein the processor is further configured to capture sensor data from an interior of the vehicle during an interaction with a service provider.

11. A method, comprising:
generating a plurality of interactions via a head unit of a vehicle;
identifying a plurality of location data within the vehicle;
determining a source vector between the plurality of interactions and the plurality of location data;
generating a filtered interaction from the plurality of interactions for the source vector; and
transmitting the filtered interaction to a target user interface from a plurality of user interfaces.

12. The method of claim 11, comprising capturing one or more of audio and video of an occupant of the vehicle from one or more hardware sensors installed within the vehicle while the plurality of interactions are occurring.

13. The method of claim 11, wherein the method further comprises identifying a closest available user interface to an occupant within the vehicle from among the plurality of user interfaces based on a location of the occupant within the vehicle, and displaying a data related to the plurality of interactions on the target user interface.

14. The method of claim 11, wherein the plurality of user interfaces are communicably coupled to the head unit of the vehicle, and the plurality of user interfaces include a plurality of display screens integrated within an interior of the vehicle.

15. The method of claim 11, comprising displaying a digital wallet screen on the target user interface, receiving digital wallet data via the digital wallet screen on the target user interface, and transmitting the digital wallet data to a service provider from the head unit of the vehicle.

16. The method of claim 11, comprising capturing multi-occupant sensor data that includes a first occupant within the vehicle interacting with a service provider and a second occupant within the vehicle interacting with the service provider.

17. The method of claim 16, wherein the determining comprises determining a location of the first occupant within the vehicle based on the multi-occupant sensor data and determine a different location of the second occupant within the vehicle based on the multi-occupant sensor data.

18. The method of claim 17, comprising displaying data related to the filtered interaction between the service provider and the first occupant on a first user interface from among the plurality of user interfaces within the vehicle based on the location of the first occupant within the vehicle, and display data related to the filtered interaction between the service provider and the second occupant on a second user interface from among the plurality of user interfaces within the vehicle based on the different location of the second occupant within the vehicle, wherein the data related to the filtered interaction is based on at least one of training an artificial intelligence (AI) model or executing the AI model.

19. A computer-readable storage medium comprising instructions stored therein which when executed by a processor cause the processor to perform:
generating a plurality of interactions via a head unit of a vehicle;
identifying a plurality of location data within the vehicle;
determining a source vector between the plurality of interactions and the plurality of location data;
generating a filtered interaction from the plurality of interactions for the source vector; and
transmitting the filtered interaction to a target user interface from a plurality of user interfaces.

20. The computer-readable storage medium of claim 19, wherein the processor further performs
capturing one or more of audio and video of an occupant of the vehicle from one or more hardware sensors installed within the vehicle while the plurality of interactions are occurring.
